(19) United States
(12) Patent Application Publication
(10) Pub. No.: US 2010/0029860 A1
(43) Pub. Date: Feb. 4, 2010

(54) ALKOXYSILANE-CONTAINING RESIN, MODIFIED ALKOXYSILANE-CONTAINING RESIN, THEIR PRODUCTION METHODS, HOT MELT ADHESIVE, AND RESIN CURED PRODUCT

(75) Inventors: Shirou Honma, Yokohama-shi (JP); Tamotsu Kunihiro, Kisarazu-shi (JP); Tsuyoshi Iwa, Narashino-shi (JP)

Correspondence Address: FOLEY AND LARDNER LLP;SUITE 500, 3000 K STREET NW, WASHINGTON, DC, 20007, US

(73) Assignee: MITSUI CHEMICALS, INC., TOKYO (JP)

(21) Appl. No.: 12/449,461

(22) PCT Filed: Jan. 15, 2008
(86) PCT No.: PCT/JP2008/050359

§ 371 Date: Aug. 10, 2009

(30) Foreign Application Priority Data
Feb. 22, 2007 (JP) 2007-042869
Jul. 10, 2007 (JP) 2007-181223
Sep. 10, 2007 (JP) 2007-234642

(51) Int. Cl. C08G 77/38

(52) U.S. Cl. 525/452

(57) ABSTRACT

An alkoxysilane-containing resin is produced by reacting a terminal carboxyl group-containing oligomer with an isocyanato alkoxysilane compound.

### TECHNICAL FIELD

The present invention relates to an alkoxysilane-containing resin, a modified alkoxysilane-containing resin, their production methods, a hot-melt adhesive agent containing those resins, and a cured resin product of those resins.

### BACKGROUND ART

Terminal isocyanate group-containing urethane prepolymers produced by reaction between polyester polyol and polyisocyanate have been widely known as reactive hot-melt adhesive agents hitherto (see, for example, Patent Document 1).

In order to impart improved heat resistance and machine strength to such reactive hot-melt adhesive agents, various processes for introducing an amide bond into a polyester polyol have conventionally been proposed.

For example, there has been proposed a hot-melt adhesive agent produced by reaction between a polyester polyamide having a terminal isocyanate group and an amino alkoxysilane compound (see, for example, Patent Document 2).

Further, there has been proposed a hygroscopic crosslinking hot-melt adhesive agent produced by reaction between a polyamide resin having a terminal amino group and an alkoxysilane compound having a terminal isocyanate group (see, for example, Patent Document 3).

Furthermore, there has been proposed a moisture-curable hot-melt adhesive composition produced by reaction between a block polyol having a polyester block and a polyamide block, and a polyisocyanate compound or a compound having a hydrolyzable silyl group (see, for example, Patent Document 4).
Patent Document 1: Japanese Unexamined Patent Publication No. 2003-277717
Patent Document 2: Japanese Unexamined Patent Publication No. 59-172575
Patent Document 3: Japanese Examined Patent Publication No. 62-41989
Patent Document 4: Japanese Unexamined Patent Publication No. 10- 110153

### DISCLOSURE OF THE INVENTION

### Problems to be Solved

However, the hot-melt adhesive agents described above each have an amide bond introduced therein by preliminarily modifying a polyester polyol with a polyamide unit (see Patent Documents 2 and 4) or by preliminarily using a polyamide in place of the polyester polyol (see Patent Document 3).

However, any of the hot-melt adhesive agents described above fails to exhibit sufficient heat resistance and machine strength. Accordingly, further improved physical properties are required.

It is an object of the present invention to provide an alkoxysilane-containing resin and a modified alkoxysilane-containing resin, which are excellent in heat resistance and machine strength, their production methods, a hot-melt adhesive agent containing those resins, and a cured resin product of those resins.

### Means for Solving the Problem

To achieve the above object, the alkoxysilane-containing resin of the present invention is produced by reacting a terminal carboxyl group-containing oligomer and an isocyanato alkoxysilane compound.

In the alkoxysilane-containing resin of the present invention, it is preferable that the terminal carboxyl group-containing oligomer is at least one kind selected from the group consisting of polyester polycarboxylic acid produced by reaction between a polybasic acid and a polyhydric alcohol, polyester polyamide polycarboxylic acid produced by reaction between the polyester polycarboxylic acid and a polyisocyanate compound, dimer acid, and amide-modified dimer acid produced by reaction between the dimer acid and a polyisocyanate compound.

In the alkoxysilane-containing resin of the present invention, it is preferable that the isocyanato alkoxysilane compound is represented by the following general formula (1):

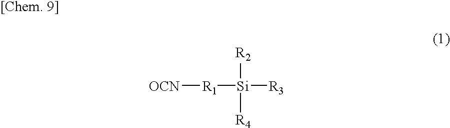

(where R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

The modified alkoxysilane-containing resin of the present invention is produced by reacting an alkoxysilane-containing resin produced by reacting a terminal carboxyl group-containing oligomer with an isocyanato alkoxysilane compound, and an ethylenically unsaturated bond-containing compound.

In the modified alkoxysilane-containing resin of the present invention, it is preferable that the terminal carboxyl group-containing oligomer is at least one kind selected from the group consisting of polyester polycarboxylic acid produced by reaction between a polybasic acid and a polyhydric alcohol, polyester polyamide polycarboxylic acid produced by reaction between the polyester polycarboxylic acid and a polyisocyanate compound, dimer acid, and amide-modified dimer acid produced by reaction between the dimer acid and a polyisocyanate compound.

In the modified alkoxysilane-containing resin of the present invention, it is preferable that the isocyanato alkoxysilane compound is represented by the following general formula (1):

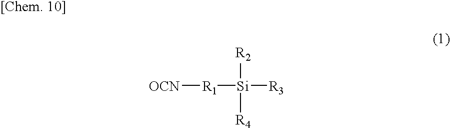

(where R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

In the modified alkoxysilane-containing resin of the present invention, it is preferable that the ethylenically unsaturated bond-containing compound is an acrylate compound, and that the acrylate compound comprises at least one acrylate compound selected from the group consisting of compounds represented by the following general formula (2) and compounds represented by the following general formula (3):

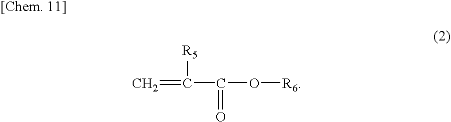

(where R5 represents a hydrogen atom, a halogen atom, or an alkyl group having 1 to 12 carbon atoms, and R6 represents a monovalent hydrocarbon group having 1 to 20 carbon atoms,)

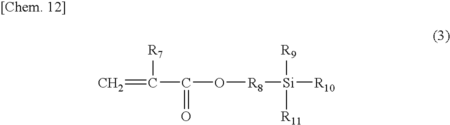

(where R7 represents a hydrogen atom, a halogen atom, or an alkyl group having 1 to 12 carbon atoms, R8 represents an alkylene group having 1 to 20 carbon atoms, and R9, R10, and R11 are the same or different from each other, and each represents an alkoxy group or an alkyl group having 1 to 20 carbon atoms, with proviso that at least one of R9, R10, and R11 represents an alkoxy group.)

The hot-melt adhesive agent of the present invention includes an alkoxysilane-containing resin produced by reacting a terminal carboxyl group-containing oligomer and an isocyanato alkoxysilane compound; and/or a modified alkoxysilane-containing resin produced by reacting the alkoxysilane-containing resin and an ethylenically unsaturated bond-containing compound.

It is preferable that the hot-melt adhesive agent of the present invention is a one-part moisture-curable adhesive agent.

The cured resin product of the present invention is produced by curing an alkoxysilane-containing resin produced by reacting a terminal carboxyl group-containing oligomer and an isocyanato alkoxysilane compound; and/or a modified alkoxysilane-containing resin produced by reacting the alkoxysilane-containing resin and an ethylenically unsaturated bond-containing compound.

The method for producing the alkoxysilane-containing resin of the present invention includes the step of reacting a terminal carboxyl group-containing oligomer and an isocyanato alkoxysilane compound in the presence of a catalyst selected from alkali metal salts and/or alkaline earth metal salts in an amount 0.001 to 10 parts by mole per 100 parts by mole of all the carboxyl groups in the terminal carboxyl group-containing oligomer.

In the method for producing the alkoxysilane-containing resin of the present invention, it is preferable that the reaction is performed at 150° C. or less.

In the method for producing the alkoxysilane-containing resin of the present invention, it is preferable that the catalyst is magnesium stearate.

In the method for producing the alkoxysilane-containing resin of the present invention, it is preferable that the terminal carboxyl group-containing oligomer is at least one kind selected from the group consisting of polyester polycarboxylic acid produced by reaction between a polybasic acid and a polyhydric alcohol, polyester polyamide polycarboxylic acid produced by reaction between the polyester polycarboxylic acid and a polyisocyanate compound, dimer acid, and amide-modified dimer acid produced by reaction between the dimer acid and a polyisocyanate compound.

In the method for producing the alkoxysilane-containing resin of the present invention, it is preferable that the isocyanato alkoxysilane compound is represented by the following general formula (1):

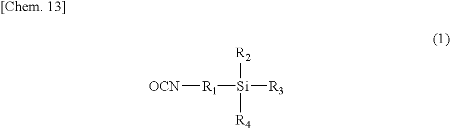

(where R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

The method for producing the modified alkoxysilane-containing resin of the present invention includes the steps of: producing an alkoxysilane-containing resin by reacting a terminal carboxyl group-containing oligomer and an isocyanato alkoxysilane compound in the presence of a catalyst selected from alkali metal salts and/or alkaline earth metal salts in an amount 0.001 to 10 parts by mole per 100 parts by mole of all the carboxyl groups in the terminal carboxyl group-containing oligomer; and reacting the alkoxysilane-containing resin and an ethylenically unsaturated bond-containing compound.

In the method for producing the modified alkoxysilane-containing resin of the present invention, it is preferable that the terminal carboxyl group-containing oligomer and the isocyanato alkoxysilane compound are reacted at 150° C or less.

In the method for producing the modified alkoxysilane-containing resin of the present invention, it is preferable that the catalyst is magnesium stearate.

In the method for producing the modified alkoxysilane-containing resin of the present invention, it is preferable that using alkyl peroxide as a reaction initiator, the alkoxysilane-containing resin and the ethylenically unsaturated bond-containing compound are reacted, and that the reaction initiator is peroxyketal.

In the method for producing the modified alkoxysilane-containing resin of the present invention, it is preferable that the terminal carboxyl group-containing oligomer is at least one kind selected from the group consisting of polyester polycarboxylic acid produced by reaction between a polybasic acid and a polyhydric alcohol, polyester polyamide polycarboxylic acid produced by reaction between the polyester polycarboxylic acid and a polyisocyanate compound, dimer acid, and amide-modified dimer acid produced by reaction between the dimer acid and a polyisocyanate compound.

In the method for producing the modified alkoxysilane-containing resin of the present invention, it is preferable that the isocyanato alkoxysilane compound is represented by the following general formula (1):

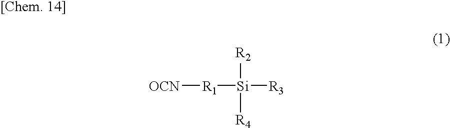

(where R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

In the method for producing the modified alkoxysilane-containing resin of the present invention, it is preferable that the ethylenically unsaturated bond-containing compound is an acrylate compound, and that the acrylate compound includes at least one acrylate compound selected from the group consisting of a compound represented by the following general formula (2) and a compound represented by the following general formula (3):

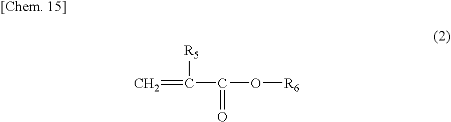

(where R5 represents a hydrogen atom, a halogen atom, or an alkyl group having 1 to 12 carbon atoms, and R6 represents a monovalent hydrocarbon group having 1 to 20 carbon atoms,)

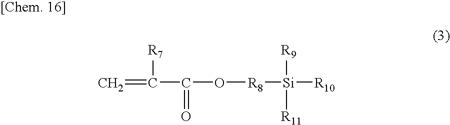

(where R7 represents a hydrogen atom, a halogen atom, or an alkyl group having 1 to 12 carbon atoms, R8 represents an alkylene group having 1 to 20 carbon atoms, and R9, R10, and R11 are the same or different from each other, and each represents an alkoxy group or an alkyl group having 1 to 20 carbon atoms, with proviso that at least one of R9, R10, and R11 represents an alkoxy group.)

### EFFECT OF THE INVENTION

The alkoxysilane-containing resin of the present invention has an amide bond introduced therein by reacting a terminal carboxyl group-containing oligomer with an isocyanato alkoxysilane compound. Further, the modified alkoxysilane-containing resin of the present invention is produced by reacting the alkoxysilane-containing resin with an ethylenically unsaturated bond-containing compound.

Therefore, the alkoxysilane-containing resin and modified alkoxysilane-containing resin of the present invention have excellent heat resistance and machine strength, and can be used, for example, for a hot-melt adhesive agent.

Furthermore, the method for producing an alkoxysilane-containing resin and the method for producing a modified alkoxysilane-containing resin according to the present invention each are capable of easily introducing an amide bond which can improve heat resistance and machine strength.

### EMBODIMENT OF THE INVENTION

First, the alkoxysilane-containing resin of the present invention will be described in detail.

The alkoxysilane-containing resin of the present invention can be produced by reacting a terminal carboxyl group-containing oligomer with an isocyanato alkoxysilane compound.

In the present invention, the terminal carboxyl group-containing oligomer is a polycarboxylic acid having a carboxyl group (including an acid anhydride group) at the molecular terminal thereof, of which the number average molecular weight is in the range of, for example, 200 to 40000, or preferably, 500 to 10000. The number average molecular weight can be measured by gel permeation chromatography (GPC). In the GPC measurement, a number average molecular weight from a peak including the molecular weight (retention time) at the highest peak in the measured chromatogram is calculated based on a calibration curve prepared using standard polyethylene glycol. Thus, the number average molecular weight is determined as a conversion value of the standard polyethylene glycol. The terminal carboxyl group-containing oligomer has a viscosity, which has been measured at 100° C. with a cone and plate viscometer, of preferably 60000 mPa·s or less.

Examples of the terminal carboxyl group-containing oligomer include a polyester polycarboxylic acid, a polyester polyamide polycarboxylic acid, a dimer acid, and an amide-modified dimer acid.

The polyester polycarboxylic acid can be produced, for example, by reaction between a polybasic acid and a polyhydric alcohol.

Examples of the polybasic acid include dicarboxylic acids such as oxalic acid, malonic acid, succinic acid, methyl succinic acid, glutaric acid, adipic acid, pimelic acid, suberic acid, azelaic acid, sebacic acid, other aliphatic dicarboxylic acid (having 11 to 13 carbon atoms), hydrogenated dimer acid, maleic acid, fumaric acid, itaconic acid, orthophthalic acid, isophthalic acid, terephthalic acid, toluene dicarboxylic acid, dimer acid, and HET acid; and alkyl esters of those dicarboxylic acids.

Further examples of the polybasic acid include acid anhydrides derived from the carboxylic acids exemplified above, such as oxalic anhydride, succinic anhydride, maleic anhydride, phthalic anhydride, 2-alkyl (12 to 18 carbon atoms) succinic anhydride, tetrahydrophthalic anhydride, and trimellitic anhydride.

Still further examples of the polybasic acid include acid halides derived from the carboxylic acids exemplified above, such as oxalic acid dichloride, adipic acid dichloride, and sebacic acid dichloride.

These polybasic acids can be used alone or in combination of two or more kinds. Among them, a dicarboxylic acid and an alkyl ester thereof are preferable.

Examples of the polyhydric alcohol include diols having two hydroxyl groups, and polyols having three or more hydroxyl groups.

Examples of the diol include aliphatic diols including C2 to C22 alkane diols such as ethylene glycol, propylene glycol, trimethylene glycol, 1,4-butylene glycol, 1,3-butylene glycol, 1,2-butylene glycol, 1,5-pentanediol, 3-methyl-1,5-pentanediol, 2,2-dimethyl-1,3-propanediol, neopentyl glycol, 1,6-hexandiol, 2,5-hexandiol, 2,2-diethyl-1,3-propanediol, 3,3-dimethylol heptane, 2-ethyl-2-butyl-1,3-propanediol, 1,12-dodecanediol, and 1,18-octadecanediol; and alkenediols such as 2-butene-1,4-diol and 2,6-dimethyl-1-octene-3,8-diol.

Further examples of the diol include alicyclic diols such as 1,4-cyclohexanediol, 1,4-cyclohexanedimethanol, and hydrogenated bisphenol A or C2 to C4 alkylene oxide adducts thereof.

Still further examples of the diol include aromatic diols such as resorcinol, xylylene glycol, bis(hydroxyethoxy)benzene, bis(hydroxyethylene)terephthalate, bisphenol A, bisphenol S, bisphenol F, and C2 to C4 alkylene oxide adducts thereof.

Still further examples of the diol include polyether diols such as diethylene glycol, triethylene glycol, dipropylene glycol, polyethylene glycol, polypropylene glycol, polyethylene polypropylene block glycol, and polytetramethylene ether glycol.

Examples of the polyols having three or more hydroxyl groups include triols such as glycerol, 2-methyl-2-hydroxymethyl-1,3-propanediol, 2,4-dihydroxy-3-hydroxymethyl pentane, 1,2,6-hexane triol, trimethylolethane, trimethylolpropane, 2-methyl-2-hydroxymethyl- 1,3-propanediol, 2,4-dihydroxy-3-(hydroxymethyl)pentane, 2,2-bis(hydroxymethyl)-3-butanol, and other aliphatic triols (8 to 24 carbon atoms); and polyols having four or more hydroxyl groups such as tetramethylolmethane, pentaerythritol, dipentaerythritol, D-sorbitol, xylitol, D-mannitol, and D-mannite.

These polyhydric alcohols can be used alone or in combination of two or more kinds. Among them, a diol is preferable.

The polyester polycarboxylic acid can be produced by mixing a polybasic acid and a polyhydric alcohol at such a ratio that the amount of the acid group (a carboxyl group, a carboxylate, an acid anhydride group, or an acid halide) of the polybasic acid exceeds that of the hydroxyl group of the polyhydric alcohol (the COOH/OH ratio exceeds 1.0, or preferably 1.01 to 2.10), and subjecting the mixture to an esterification reaction.

The esterification reaction, such as a condensation reaction or a transesterification reaction, may be performed under conditions known in the art, for example, at normal pressure in an inert gas atmosphere, at a reaction temperature of 100 to 250° C., for a reaction time of 1 to 50 hours, and if necessary, a catalyst (organic tin catalyst, organic titanium catalyst, amine catalyst, alkali metal salt and alkaline earth metal salt both to be described later, etc.) or a solvent can be used.

The polybasic acid and the polyhydric alcohol may be allowed to react in a stepwise process. Specifically, first, a polybasic acid and a polyhydric alcohol are allowed to react at such a ratio that the amount of a hydroxyl group of the polyhydric alcohol exceeds that of an acid group of the polybasic acid, to thereby produce a polyester polyol. Subsequently, a polybasic acid is mixed with the polyester polyol at such a ratio that the amount of the acid group of the polybasic acid finally exceeds that of the hydroxyl group of the polyester polyol, to thereby produce a polyester polycarboxylic acid. According to this method, a polyester polycarboxylic acid of which the structural units derived from the polybasic acid are different between at the terminal of the molecule and at the other sites can be produced.

The polyester polycarboxylic acid thus produced has a number average molecular weight of, for example, 200 to 20000, or preferably 500 to 10000. It also has an acid value of, for example, 5 to 600 mg KOH/g, or preferably 10 to 250 mg KOH/g, and a hydroxyl value of 5 mg KOH/g or less, or preferably 3 mg KOH/g or less.

The polyester polyamide polycarboxylic acid can be produced, for example, by reacting the polyester polycarboxylic acid produced in the above manner with a polyisocyanate compound.

Examples of the polyisocyanate compound include an aliphatic polyisocyanate, an alicyclic polyisocyanate, an aralkyl polyisocyanate, and an aromatic polyisocyanate.

Examples of the aliphatic polyisocyanate include aliphatic diisocyanates such as hexamethylene diisocyanate (HDI), trimethylene diisocyanate, tetramethylene diisocyanate, pentamethylene diisocyanate, 1,2-propylene diisocyanate, 1,2-, 2,3- or 1,3-butylene diisocyanate, 2,4,4- or 2,2,4-trimethyl-hexamethylene diisocyanate, and 2,6-diisocyanatomethylcaproate.

Examples of the alicyclic polyisocyanate include alicyclic diisocyanates such as 3-isocyanatomethyl-3,5,5-trimethylcyclohexyl isocyanate (isophorone diisocyanate, IPDI), 4,4′-, 2,4′- or 2,2′-dicyclohexylmethane diisocyanate or a mixture thereof (H₁₂MDI), 1,3- or 1,4-bis(isocyanatomethyl)cyclohexane or a mixture thereof (hydrogenated xylylene diisocyanate, H₆XDI), 2,5- or 2,6-bis(isocyanatomethyl)norbornane or a mixture thereof (NBDI), 1,3-cyclopentane diisocyanate, 1,4-cyclohexane diisocyanate, 1,3-cyclohexane diisocyanate, methyl-2,4-cyclohexane diisocyanate, and methyl-2,6-cyclohexane diisocyanate.

Examples of the aralkyl polyisocyanate include aralkyl diisocyanates such as 1,3- or 1,4-xylylene diisocyanate or a mixture thereof (XDI), 1,3- or 1,4-tetramethylxylylene diisocyanate or a mixture thereof (TMXDI), and ω,ω′-diisocyanato-1,4-diethylbenzene.

Examples of the aromatic polyisocyanate include aromatic diisocyanates such as 4,4′-, 2,4′- or 2,2′-diphenylmethane diisocyanate or a mixture thereof (MDI), 2,4- or 2,6-tolylene diisocyanate or a mixture thereof (TDI), 3,3′-dimethoxybiphenyl-4,4′-diisocyanate, 1,5-naphthalene diisocyanate (NDI), m-, or p-phenylene diisocyanate or a mixture thereof, 4,4′-diphenyl diisocyanate, and 4,4′-diphenylether diisocyanate.

Further, examples of the polyisocyanate compound include multimers (e.g., dimers, trimers, etc.) of the above-mentioned polyisocyanates; and modified polyisocyanates thereof such as a biuret-modified polyisocyanate formed by reaction of the above-mentioned polyisocyanate or a multimer thereof with water, an allophanate-modified polyisocyanate formed by reaction of the above-mentioned polyisocyanate or a multimer thereof with an alcohol or the above-mentioned polyhydric alcohol, an oxadiazinetrione-modified polyisocyanate formed by reaction of the above-mentioned polyisocyanate or a multimer thereof with carbon dioxide, or a polyol-modified polyisocyanate formed by reaction of the above-mentioned polyisocyanate or a multimer thereof with the above-mentioned polyhydric alcohol. The polyisocyanate compound further contains a sulfur-containing polyisocyanates such as phenyl diisothiocyanate.

These polyisocyanate compounds can be used alone or in combination of two or more kinds. Among them, an alicyclic diisocyanate, an aralkyl diisocyanate, and an aromatic diisocyanate are preferable.

The polyester polyamide polycarboxylic acid can be produced by mixing a polyester polycarboxylic acid and a polyisocyanate compound at such a ratio that the amount of the carboxyl group of the polyester polycarboxylic acid exceeds that of the isocyanate group of the polyisocyanate compound (the COOH/NCO ratio exceeds 1.0, or preferably 1.01 to 2.10), and subjecting the mixture to an amidation reaction.

The amidation reaction may be performed under conditions known in the art, for example, at normal pressure in an inert gas atmosphere, at a reaction temperature of 40 to 250° C., for a reaction time of 0.5 to 50 hours, and if necessary, a catalyst (organic tin catalyst, organic titanium catalyst, amine catalyst, alkali metal salt and alkaline earth metal salt both to be described later, etc.), a solvent, or a defoaming agent can be used. In the amidation reaction, specifically, for example, a polyester polycarboxylic acid is preliminarily charged and a polyisocyanate compound is added dropwise thereto.

The polyester-polyamide polycarboxylic acid thus produced has a number average molecular weight of, for example, 500 to 40000, or preferably 1000 to 10000. It also has an acid value of, for example, 3 to 250 mg KOH/g, or preferably 10 to 130 mg KOH/g, and an isocyanate group content of 1% by weight or less, or preferably 0.5% by weight or less.

The dimer acid is a dimer formed by an intermolecular polymerization reaction of two or more unsaturated acid molecules from a vegetable oil fatty acid (e.g., tall oil fatty acid, soybean oil fatty acid, etc.), and the one used as an industrial raw material predominantly contains a dimer of an unsaturated fatty acid having 18 carbon atoms (dimer acid content: about 71 to 76% by weight) and further contains a monomer acid or a trimmer acid.

As the dimer acid, for example, a high-purity dimer acid produced by removing the trimmer acid and the monomer acid by molecular distillation and purification, a hydrogenated dimer acid produced by causing the unsaturated bond disappearance by a hydrogenation reaction, or a hydrogenated high-purity dimer acid produced by removing the trimmer acid and the monomer acid by molecular distillation and purification, and by causing the unsaturated bond disappearance by a hydrogenation reaction is preferably used, or a hydrogenated high-purity dimer acid is more preferably used.

The amide-modified dimer acid can be produced, for example, by reacting the above-mentioned dimer acid with the above-mentioned polyisocyanate compound.

Preferred examples of the polyisocyanate compound include an alicyclic diisocyanate, an aralkyl diisocyanate, and an aromatic diisocyanate.

The amide-modified dimer acid can be produced by mixing a dimer acid and a polyisocyanate compound at such a ratio that the amount of the carboxyl group of the dimer acid exceeds that of the isocyanate group of the polyisocyanate compound (the COOH/NCO ratio exceeds 1.0, or preferably 1.01 to 2.10), and subjecting the mixture to an amidation reaction.

The amidation reaction may be performed under conditions known in the art, for example, at normal pressure in an inert gas atmosphere, at a reaction temperature of 40 to 250° C., for a reaction time of 0.5 to 50 hours, and if necessary, a catalyst (organic tin catalyst, organic titanium catalyst, amine catalyst, alkali metal salt and alkaline earth metal salt both to be described later, etc.), a solvent, or a defoaming agent can be used. In the amidation reaction, specifically, for example, a dimer acid is preliminarily charged and a polyisocyanate compound is added dropwise thereto.

The amide-modified dimer acid thus produced has a number average molecular weight of, for example, 500 to 40000, or preferably 1000 to 10000. It also has an acid value of, for example, 3 to 250 mg KOH/g, or preferably 10 to 130 mg KOH/g, and an isocyanate group content of 1% by weight or less, or preferably 0.5% by weight or less.

As the terminal carboxyl group-containing oligomer, the polyester polycarboxylic acid, the polyester polyamide polycarboxylic acid, the dimer acid, and the amide-modified dimer acid can be used alone or in combination.

In the present invention, the isocyanato alkoxysilane compound is a silane compound having both of at least one isocyanate group and at least one alkoxy group, and is represented, for example, by the following general formula (1):

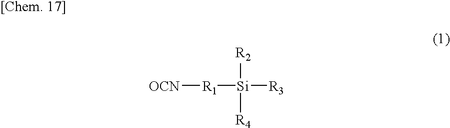

(where R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

In the general formula (1), examples of the alkylene group having 1 to 20 carbon atoms represented by R1 include methylene, ethylene, propylene, butylene, pentylene, hexylene, heptylene, octylene, nonylene, decylene, dodecylene, tetradecylene, hexadecylene, octadecylene, and eicosanylene. Among them, an alkylene group having 1 to 4 carbon atoms is preferable.

Examples of the alkoxy group having 1 to 20 carbon atoms represented by R2, R3, and R4 include methoxy, ethoxy, propoxy, isopropoxy, butoxy, isobutoxy, sec-butoxy, tert-butoxy, pentyloxy, isopentyloxy, neopentyloxy, hexyloxy, octyloxy, decyloxy, dodecyloxy, tetradecyloxy, hexadecyloxy, octadecyloxy, and eicosanyloxy. Among them, an alkoxy group having 1 to 4 carbon atoms is preferable.

Examples of the alkyl group having 1 to 20 carbon atoms represented by R2, R3, and R4 include methyl, ethyl, propyl, isopropyl, butyl, isobutyl, sec-butyl, tert-butyl, pentyl, isopentyl, sec-pentyl, hexyl, heptyl, n-octyl, isooctyl, 2-ethylhexyl, nonyl, decyl, isodecyl, dodecyl, tetradecyl, hexadecyl, octadecyl, and eicosanyl. Among them, an alkyl group having 1 to 4 carbon atoms is preferable.

In the general formula (1), when one of R2, R3, and R4 is an alkoxy group and the other two are alkyl groups, the isocyanato alkoxysilane compound in the general formula (1) represents isocyanatoalkyl-dialkylmonoalkoxysilane; when two of them are alkoxy groups and the other one is an alkyl group, the isocyanato alkoxysilane compound in the general formula (1) represents isocyanatoalkyl-monoalkyldialkoxysilane; and when three of them are alkoxy groups, the isocyanato alkoxysilane compound in the general formula (1) represents isocyanatoalkyl-trialkoxysilane. In the general formula (1), the isocyanato alkoxysilane compound is preferably an isocyanatoalkyl-trialkoxysilane.

Specific examples of the isocyanato alkoxysilane compound include γ-isocyanatopropyl trimethoxysilane, γ-isocyanatopropyl triethoxysilane, γ-isocyanatopropyl methyldimethoxysilane, γ-isocyanatopropyl methyldiethoxysilane, and γ-isocyanatopropyl ethyldimethoxysilane. Among them, γ-isocyanatopropyl triethoxysilane is preferable. These isocyanato alkoxysilane compounds can be used alone or in combination of two or more kinds.

The alkoxysilane-containing resin can be produced by mixing a terminal carboxyl group-containing oligomer and an isocyanato alkoxysilane compound at such a ratio that the amount of the carboxyl group of the terminal carboxyl group-containing oligomer is almost equivalent to that of the isocyanate group of the isocyanato alkoxysilane compound (the COOH/NCO ratio is 0.6 to 1.4, or preferably 0.9 to 1.1), and subjecting the mixture to an amidation reaction.

The amidation reaction is performed, for example, in the presence of a catalyst at a reaction temperature of 150° C. or less, or preferably 40 to 140° C., more preferably 40 to 120° C., for a reaction time of 0.5 to 50 hours, or preferably 1 to 15 hours, though not limited thereto.

Preferred examples of the catalyst include an alkali metal salt and an alkaline earth metal salt. Examples of the alkali metal salt include lithium fluoride, lithium chloride, lithium hydroxide, sodium fluoride, sodium chloride, sodium hydroxide, potassium fluoride, potassium chloride, and potassium hydroxide. Examples of the alkaline earth metal salt include calcium stearate, calcium perchlorate, calcium chloride, calcium hydroxide, magnesium stearate, magnesium perchlorate, magnesium chloride, and magnesium hydroxide. These catalysts can be used alone or in combination of two or more kinds. From the viewpoint of amide selectivity of the amidation reaction, calcium stearate, calcium perchlorate, magnesium stearate, and magnesium perchlorate are preferable, or magnesium stearate is more preferable.

The catalyst is added, for example, in an amount of 0.001 to 10 parts by mole, or preferably 0.005 to 2 parts by mole, per 100 parts by mole of all the carboxyl groups in the terminal carboxyl group-containing oligomer. When the amount of the catalyst added is less than this range, the amidation reaction may not sufficiently proceed, which in turn may decrease productivity. On the other hand, even when the amount is more than this range, the amide selectivity of the amidation reaction does not change, which may be economically disadvantageous.

Further, when the reaction temperature is in the above range, production can be stable. On the other hand, when the reaction temperature exceeds 150° C., the alkoxysilyl group of the isocyanato alkoxysilane compound may be hydrolyzed to generate alcohol. The alcohol thus generated reacts with the isocyanate group to inhibit reaction between the isocyanate group and the carboxyl group. As a result, physical properties of the resulting cured resin product, such as tensile strength, may deteriorate. On the other hand, when the reaction temperature is too low, the reaction between the carboxyl group of the terminal carboxyl group-containing oligomer and the isocyanate group of the isocyanato alkoxysilane compound may not sufficiently proceed, which in turn may decrease productivity.

The amidation reaction can be preferably performed under normal pressure. It can also be performed under a reduced pressure while removing the carbon dioxide generated during the reaction, and furthermore, it can be performed under pressurization with the carbon dioxide generated during the reaction.

In the amidation reaction, the isocyanate group and the alkoxysilyl group are decomposed when reacted with water (moisture in the air, etc.). Therefore, in order to avoid contact with moisture in the air, this reaction is preferably performed under an inert gas atmosphere. Examples of the inert gas include nitrogen gas and helium gas, and nitrogen gas is preferable.

If necessary, a solvent can also be used in the amidation reaction.

In this reaction, specifically, the terminal carboxyl group-containing oligomer, the isocyanato alkoxysilane compound, and the catalyst may be mixed at once, or the terminal carboxyl group-containing oligomer and the isocyanato alkoxysilane compound can be preliminarily mixed, followed by mixing the catalyst therewith.

Alternatively, the terminal carboxyl group-containing oligomer and the catalyst may be preliminarily mixed, followed by mixing the isocyanato alkoxysilane compound therewith, or the isocyanato alkoxysilane compound and the catalyst may be preliminarily mixed, followed by mixing the terminal carboxyl group-containing oligomer therewith.

When a hydroxide such as lithium hydroxide, sodium hydroxide, potassium hydroxide, calcium hydroxide, or magnesium hydroxide is used as the catalyst, the terminal carboxyl group-containing oligomer and the hydroxide are mixed to react with each other, so that water is produced. In this case, it is therefore necessary to remove water by performing dehydration treatment after the mixing and then mix the isocyanato alkoxysilane compound with the resulting mixture. This can suppress decomposition of the isocyanate group and the alkoxysilyl group due to the water thus produced.

When a plural kinds of terminal carboxyl group-containing oligomers are used together, the plural kinds of terminal carboxyl group-containing oligomers are allowed to react with an isocyanato alkoxysilane compound simultaneously, so that an alkoxysilane-containing resin containing the plural kinds of terminal carboxyl group-containing oligomers may be prepared. Alternatively, first, each of those kinds of terminal carboxyl group-containing oligomers is allowed to react with an isocyanato alkoxysilane compound to produce an alkoxysilane-containing resin per kind, and the alkoxysilane-containing resin for each kind is then mixed, so that an alkoxysilane-containing resin containing the plural kinds of terminal carboxyl group-containing oligomers may also be prepared.

The alkoxysilane-containing resin thus produced has a number average molecular weight of, for example, 350 to 40000, or preferably 500 to 10000. The amide conversion (alkoxysilane modification ratio) is usually 70 to 100%, or preferably 80 to 100%. When the amide conversion is in the above range, a cured resin product having excellent heat resistance, adhesion, and machine strength can be produced.

The alkoxysilane-containing resin is moisture-cured because it has an alkoxysilyl group at the molecular terminal thereof. Therefore, the alkoxysilane-containing resin can be used in various fields as a one-part moisture-curable resin composition. In particular, it is useful as an adhesive component of a one-part moisture-curable hot-melt adhesive agent.

When the alkoxysilane-containing resin is used as an adhesive component of a one-part moisture-curable hot-melt adhesive agent, the mixing proportion of the alkoxysilane-containing resin is, for example, 1 part by weight or more, or preferably 10 parts by weight or more, per 100 parts by weight of the hot-melt adhesive agent.

The cured resin product produced by moisture-curing the alkoxysilane-containing resin is excellent in heat resistance, adhesion, and mechanical strength. The moisture-curing can usually be performed in the presence of a curing catalyst (described later) at high temperature.

Next, the modified alkoxysilane-containing resin of the present invention will be described in detail.

The modified alkoxysilane-containing resin of the present invention can be produced by reacting the above-mentioned alkoxysilane-containing resin with an ethylenically unsaturated bond-containing compound.

In the present invention, the ethylenically unsaturated bond-containing compound is a compound having an ethylenically unsaturated double bond.

Preferred examples of the ethylenically unsaturated bond-containing compound include acrylate compounds.

The acrylate compound includes a compound having a methacryloyl group or an acryloyl group, which is, for example, an acrylic ester (C1-C20) compound represented by the following general formula (2):

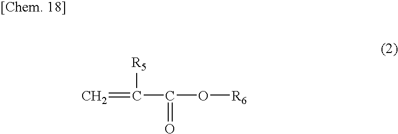

(where R5 represents a hydrogen atom, a halogen atom, or an alkyl group having 1 to 12 carbon atoms, and R6 represents a monovalent hydrocarbon group having 1 to 20 carbon atoms.)

In the general formula (2), examples of the alkyl group having 1 to 12 carbon atoms represented by R5 include methyl, ethyl, propyl, isopropyl, butyl, isobutyl, sec-butyl, tert-butyl, pentyl, isopentyl, sec-pentyl, hexyl, heptyl, n-octyl, isooctyl, 2-ethylhexyl, nonyl, decyl, isodecyl, and dodecyl. Among them, an alkyl group having 1 to 4 carbon atoms is preferable. Examples of the halogen atom represented by R5 include fluorine, chlorine, bromine, and iodine. R5 is preferably a hydrogen atom or methyl.

In the general formula (2), examples of the monovalent hydrocarbon group having 1 to 20 carbon atoms represented by R6 include an alkyl group, a cycloalkyl group, an aryl group, and an aralkyl group.

Examples of the above-mentioned alkyl group include an alkyl group having 1 to 18 carbon atoms, such as methyl, ethyl, propyl, isopropyl, butyl, isobutyl, sec-butyl, tert-butyl, pentyl, isopentyl, sec-pentyl, hexyl, heptyl, n-octyl, isooctyl, 2-ethylhexyl, nonyl, decyl, isodecyl, dodecyl, tetradecyl, hexadecyl, and octadecyl.

Examples of the above-mentioned cycloalkyl group include a cycloalkyl group having 3 to 8 carbon atoms, such as cyclopropyl, cyclobutyl, cyclopentyl, cyclohexyl, cycloheptyl, and cyclooctyl.

Examples of the above-mentioned aryl group include an aryl group having 6 to 14 carbon atoms, such as phenyl, tolyl, xylyl, biphenyl, naphthyl, anthryl, phenanthryl, and azulenyl.

Examples of the above-mentioned aralkyl group include an aralkyl group having 7 to 16 carbon atoms, such as benzyl, 1-phenylethyl, 2-phenylethyl, 1-phenylpropyl, 2-phenylpropyl, 3-phenylpropyl, diphenylmethyl, o, m, or p-methylbenzyl, o, m, or p-ethylbenzyl, o, m, or p-isopropylbenzyl, o, m, or p-tert-butylbenzyl, 2,3-, 2,4-, 2,5-, 2,6-, 3,4- or 3,5-dimethylbenzyl, 2,3,4-, 3,4,5-, or 2,4,6-trimethylbenzyl, 5-isopropyl-2-methylbenzyl, 2-isopropyl-5-methylbenzyl, 2-methyl-5-tert-butylbenzyl, 2,4-, 2,5-, or 3,5-diisopropylbenzyl, 3,5-di-tert-butylbenzyl, 1-(2-methylphenyl) ethyl, 1-(3-methylphenyl)ethyl, 1-(4-methylphenyl)ethyl, 1-(2-isopropylphenyl)ethyl, 1-(3-isopropylphenyl)ethyl, 1-(4-isopropylphenyl)ethyl, 1-(2-tert-buthylphenyl)ethyl, 1-(4-tert-buthylphenyl)ethyl, 1-(2-isopropyl-4-methylphenyl)ethyl, 1-(4-isopropyl-2-methylphenyl)ethyl, 1-(2,4-dimethylphenyl)ethyl, 1-(2,5-dimethylphenyl)ethyl, 1-(3,5-dimethylphenyl)ethyl, and 1-(3,5-di-tert-buthylphenyl)ethyl.

R6 is preferably an alkyl group, a cycloalkyl group, an aryl group, or an aralkyl group, having 1 to 9 carbon atoms, or more preferably an alkyl group having 1 to 8 carbon atoms.

Specific examples of the acrylic ester (C1-C20) compound include alkyl (meth)acrylates such as ethyl acrylate, propyl acrylate, butyl acrylate, cyclohexyl acrylate, isononyl acrylate, 2-ethylhexyl acrylate, methyl methacrylate, butyl methacrylate, cyclohexyl methacrylate, and 2-ethylhexyl methacrylate. These acrylate compounds can be used alone or in combination of two or more kinds.

The acrylate compound also includes, for example, an acrylsilane compound represented by the following general formula (3):

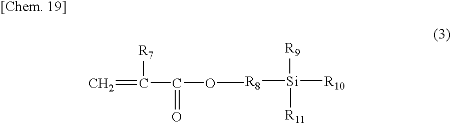

(where R7 represents a hydrogen atom, a halogen atom, or an alkyl group having 1 to 12 carbon atoms, R8 represents an alkylene group having 1 to 20 carbon atoms, and R9, R10, and R11 are the same or different from each other, and each represents an alkoxy group or an alkyl group having 1 to 20 carbon atoms, with proviso that at least one of R9, R10, and R11 represents an alkoxy group.)

In the general formula (3), examples of the halogen atom or the alkyl group having 1 to 12 carbon atoms represented by R7 include the same atom or group as that represented by R5 described above. Among them, an alkyl group having 1 to 4 carbon atoms is preferable. R7 is preferably a hydrogen atom or methyl.

In the general formula (3), examples of the alkylene group having 1 to 20 carbon atoms represented by R8 include the same group as that represented by R1 described above. Among them, an alkylene group having 1 to 4 carbon atoms is preferable.

In the general formula (3), examples of the alkoxy group or alkyl group having 1 to 20 carbon atoms represented by R9, R10, and R11 include the same group as that represented by R2, R3, and R4 described above. Among them, an alkoxy group having 1 to 4 carbon atoms and an alkyl group having 1 to 4 carbon atoms are preferable.

In the general formula (3), when one of R9, R10, and R11 is an alkoxy group and the other two are alkyl groups, the acrylsilane compound in the general formula (3) represents, for example, (meth)acryloxyalkyl-dialkylmonoalkoxysilane; when two of them are alkoxy groups and the other one is an alkyl group, the acrylsilane compound in the general formula (3) represents, for example, (meth)acryloxyalkyl-monoalkyldialkoxysilane; and when three of them are alkoxy groups, the acrylsilane compound in the general formula (3) represents, for example, (meth)acryloxyalkyl-trialkoxysilane. In the general formula (3), the acrylsilane compound is preferably (meth)acryloxyalkyl-trialkoxysilane.

Specific examples of the acrylsilane compound include γ-(meth)acryloxypropyl trimethoxysilane, γ-(meth)acryloxypropyl triethoxysilane, γ-(meth)acryloxypropyl methyldimethoxysilane, γ-(meth)acryloxypropyl methyldiethoxysilane, γ-(meth)acryloxybutyl trimethoxysilane, γ-(meth)acryloxybutyl triethoxysilane, γ-(meth)acryloxyethyl trimethoxysilane, and γ-(meth)acryloxyethyl triethoxysilane. Among them, γ-(meth)acryloxypropyl trimethoxysilane and γ-(meth)acryloxypropyl triethoxysilane are preferable. These acrylsilane compounds can be used alone or in combination of two or more kinds.

As the ethylenically unsaturated bond-containing compound, acrylate compounds (acrylic ester (C1-C20) compounds and acrylsilane compounds) can be used alone or in combination, and further, ethylenically unsaturated bond-containing compounds other than those mentioned above can be used alone or in combination.

Examples of the ethylenically unsaturated bond-containing compound other than those mentioned above include alkenyl cyanide such as acrylonitrile and methacrylonitrile; (meth)acrylic acid such as acrylic acid and methacrylic acid; conjugated diene such as butadiene, isoprene, and chloroprene; and aromatic vinyl such as styrene, vinyltoluene, and a-methylstyrene. Examples thereof further include crosslinking vinyl compounds, for example, aromatic divinyl compounds such as divinylbenzene; and alkanepolyol poly(meth)acrylates such as ethylene glycol di(meth)acrylate, butylene glycol di(meth)acrylate, hexanediol di(meth)acrylate, hexanediol di(meth)methacrylate, and trimethylolpropane di(meth)acrylate. Examples thereof also include unsaturated carboxylic acid allyl esters such as allyl acrylate, allyl methacrylate, diallyl maleate, diallyl fumarate, and diallyl itaconate.

The alkoxysilane-containing resin and the ethylenically unsaturated bond-containing compound are allowed to react by mixing the ethylenically unsaturated bond-containing compound in a proportion of, for example, 1 to 200 parts by weight, or preferably 5 to 100 parts by weight, per 100 parts by weight of the alkoxysilane-containing resin, and then reacting the mixture in the presence of a reaction initiator at a reaction temperature of, for example, 90 to 180° C., preferably 100 to 160° C., or more preferably 110 to 140° C. for reaction time of 0.5 to 50 hours, or preferably 1 to 15 hours.

Examples of the reaction initiator include a radical generator, and alkyl peroxide is preferable. Examples of the alkyl peroxide include dialkyl peroxides such as di-t-butyl peroxide, di-t-hexyl peroxide, α,α′-bis(2-t-butylperoxy isopropyl)benzene, di-α-cumyl peroxide, 2,5-dimethyl-2,5-bis(t-butyl peroxide)hexane, and t-butyl-α-cumyl peroxide; alkyl peresters such as t-butylperoxy neodecanoate, t-butylperoxy pivalate, t-butylperoxy-2-ethylhexanoate, t-butylperoxy isobutylate, t-butylperoxy benzoate, and t-butylperoxy acetate; and peroxyketals such as 1,1-bis(t-butylperoxy) 2-methylcyclohexane, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)cyclohexane, 2,2-bis(4,4-dibutylperoxy cyclohexyl)propane, 2,2-bis(t-butylperoxy)butane, and n-butyl-4,4-bis(t-butylperoxy)valerate. Among them, peroxyketals are preferable, or 1,1-bis(t-butylperoxy)cyclohexane is more preferable. These alkyl peroxides can be used alone or in combination of two or more kinds.

The reaction initiator is added in a proportion of, for example, 0.01 to 10 parts by mole, or preferably 0.05 to 5 parts by mole, per 1 part by mole of the alkoxysilane-containing resin.

This reaction can be preferably performed under normal pressure. It can also be preferably performed under an inert gas atmosphere in order to avoid decomposition of the alkoxysilyl group due to moisture. Examples of the inert gas include nitrogen gas, and helium gas, and nitrogen gas is preferable. If necessary, a solvent can also be used in the reaction.

In this reaction, specifically, the alkoxysilane-containing resin, the ethylenically unsaturated bond-containing compound, and the reaction initiator may be mixed at once, or the alkoxysilane-containing resin and the ethylenically unsaturated bond-containing compound may be preliminarily mixed, followed by mixing the resulting mixture and the reaction initiator.

Alternatively, the alkoxysilane-containing resin and the reaction initiator may be preliminarily mixed, followed by mixing the resulting mixture and the ethylenically unsaturated bond-containing compound, or the ethylenically unsaturated bond-containing compound and the reaction initiator may be preliminarily mixed, followed by mixing the resulting mixture and the alkoxysilane-containing resin.

It should be noted that when the alkoxysilane-containing resin, the ethylenically unsaturated bond-containing compound, and the reaction initiator are mixed at once, temperature may rapidly increase in some cases, so that the other methods are preferably used. For example, by sequentially adding any of the components to the other components, an abrupt increase of the temperature can be suppressed. In the case of the sequential addition, the duration of the addition is in the range of, for example, 5 to 600 minutes, preferably 30 to 480 minutes, or more preferably 60 to 360 minutes.

In one embodiment of this reaction, for example, a hydrogen atom is abstracted from the main chain of the alkoxysilane-containing resin with a reaction initiator, whereby the ethylenically unsaturated bond-containing compound is graft-polymerized onto the alkoxysilane-containing resin. Therefore, in one embodiment of the modified alkoxysilane-containing resin thus produced according to the present invention, for example, the ethylenically unsaturated bond-containing compound is grafted on the alkoxysilane-containing resin.

In the modified alkoxysilane-containing resin of the present invention thus produced, the content of the ethylenically unsaturated bond-containing compound (e.g., acrylic polymer content) is usually 1% or more, or preferably 5 to 50%. When the content of the ethylenically unsaturated bond-containing compound is in the above range, curing can be performed in a relatively short period of time and a cured resin product having excellent heat resistance, adhesion, and machine strength can also be produced. The modified alkoxysilane-containing resin of the present invention also has a number average molecular weight of 400 to 40000, or preferably 500 to 10000.

The modified alkoxysilane-containing resin is moisture-cured by hydrolysis of the alkoxysilyl group. Therefore, the modified alkoxysilane-containing resin can be used in various fields as a one-part moisture-curable resin composition. In particular, it is useful as an adhesive component of a one-part moisture-curable hot-melt adhesive agent.

When the modified alkoxysilane-containing resin is used as an adhesive component of a one-part moisture-curable hot-melt adhesive agent, the mixing proportion of the modified alkoxysilane-containing resin is, for example, 1 part by weight or more, or preferably 10 parts by weight or more, per 100 parts by weight of the hot-melt adhesive agent.

The cured resin product produced by moisture-curing the modified alkoxysilane-containing resin is excellent in heat resistance, adhesion, and mechanical strength. For moisture-curing, for example, heating is performed at a temperature of room temperature to 200° C. for 1 to 800 hours in the atmosphere. Thus, the modified alkoxysilane-containing resin is readily moisture-cured.

To the one-part moisture-curable resin composition containing the alkoxysilane-containing resin and/or the modified alkoxysilane-containing resin, if necessary, an additive can be added without inhibiting the excellent effect of the present invention.

Examples of the additive include a curing catalyst, a silane coupling agent, an internal releasing agent, a tackifier, a softening agent, a stabilizer, an antioxidant, an ultraviolet absorber, a light stabilizer, a plasticizer, a filler, a dye, a pigment, and an optical brightener.

Examples of the curing catalyst include an organotin catalyst, a metal complex, a basic catalyst, and an organic phosphoric acid compound.

Examples of the organotin catalyst include dibutyltin dilaurate, dioctyltin dimaleate, dibutyltin phthalate, stannous octoate, dibutyltin methoxide, dibutyltin diacetylacetate, and dibutyltin diacetate.

Examples of the metal complex include titanate compounds such as tetrabuthyl titanate, tetraisopropyl titanate, and triethanolamine titanate; metal carboxylates such as lead octylate, lead naphthenate, nickel naphthenate, and cobalt naphthenate; and metal acetylacetonate complexes such as aluminum acetyl acetonate complex and vanadium acetyl acetonate complex.

Examples of the basic catalyst include primary amines such as methylamine, ethylamine, propylamine, isopropylamine, isopropyl alcohol amine, butylamine, 1-ethyl butylamine, isobutylamine, pentylamine, octylamine, laurylamine, monoethanolamine, diethylamino propylamine, oleylamine, cyclohexylamine, guanidine, 2-ethylhexylamine, triethylenetetramine, aniline, phenylenediamine, toluidine, toluylamine, benzylamine, xylenediamine, and naphthylamine; secondary amines such as dimethylamine, diethylamine, diethanolamine, diethylenetriamine, dibutylamine, N-methyl-butylamine, piperidine, diisopentylamine, N-ethylnaphthylamine, benzylaniline, and diphenylguanidine; tertiary amines such as trimethylamine, triethylamine, triethanolamine, tripropylamine, tributylamine, N,N-dimethyl-butylamine, N,N-dimethyl-octylamine, N,N-dimethyl-laurylamine, 1,4-diazabicyclo[2.2.2]octane (DABCO), 1,8-diazabicyclo[5.4.0]undec-7-ene (DBU); and quaternary ammonium salts such as tetramethylammonium chloride and benzalkonium chloride.

Examples of the organic phosphoric acid compound include monomethylphosphoric acid, di-n-butylphosphoric acid, and triphenyl phosphate. Further, other acid catalysts and basic catalysts may be used.

Among them, an organotin catalyst and a metal complex are preferable. These curing catalysts can be used alone or in combination of two or more kinds. The mixing proportion of the curing catalyst is in the range of, for example, 0.0001 to 10 parts by weight, or preferably 0.001 to 5 parts by weight, per 100 parts by weight of the one-part moisture-curable resin composition.

Examples of the silane coupling agent include alkoxysilanes such as tetramethoxysilane and tetraethoxysilane; aminosilanes such as N-β-(aminoethyl)-γ-aminopropyl trimethoxysilane, γ-aminopropyl trimethoxysilane, γ-aminopropyl triethoxysilane, N-β-(aminoethyl)-γ-aminopropyl triethoxysilane, N-γ-(aminoethyl)-γ-propylmethyl dimethoxysilane, n-(dimethoxymethylsilylpropyl)ethylenediamine, n-(triethoxysilylpropyl)ethylenediamine, and N-phenyl-γ-aminopropyl trimethoxysilane; epoxysilanes such as γ-glycidoxypropyltrimetoxysilane, γ-glycidoxypropyltriethoxysilane, β-(3,4-epoxycyclohexyl)ethyltrimethoxysilane, and di(γ-glycidoxypropyl)dimethoxysilane; vinylsilanes such as vinyltriethoxysilane; isocyanatesilanes such as the above-mentioned isocyanato alkoxysilane compound; and chlorosilanes such as vinyl trichlorosilane.

Among them, an alkoxysilane and an aminosilane are preferable. From the viewpoint of improvement in mechanical properties, an aminosilane is preferable. These silane coupling agents can be used alone or in combination of two or more kinds. The mixing proportion of the silane coupling agent is in the range of, for example, 0.01 to 50 parts by weight, or preferably 0.1 to 30 parts by weight, per 100 parts by weight of the one-part moisture-curable resin composition.

When used as a one-part moisture-curable type hot-melt adhesive agent, for example, the one-part moisture-curable resin composition is heat-melted with a known coating apparatus equipped with a heating device, such as a roll coater, a spray coater, and a hand spray gun, and then applied to adherends in various patterns with such apparatus, whereby the adherends can be bonded together. At this time, the adherends may be bonded together before curing of the hot-melt adhesive agent, or they can be bonded together after the hot-melt adhesive agent once cured is reheated and activated.

Examples of the adherend include iron, copper, aluminum, tin plate, stainless steel (SUS), coated steel sheet, zinc steel sheet, polyethylene, polypropylene, PET, acrylic resin, ABS resin, vinyl chloride resin, polycarbonate, polyamide (nylon, aramid), polystyrene, polyurethane, rubber, wood, plywood, particle board, cardboard, paper, and cloth, though not limited thereto.

### EXAMPLES

While in the following, the present invention will be described in further detail with reference to Synthesis Examples, Examples, and Comparative Examples, the present invention is not limited to any of them. Analyses and measurements in Synthesis Examples, Examples, and Comparative Examples were performed according to the following processes.

### (Acid Value)

Determined according to “Partial acid value” under Section 5.3 “Acid value” of JIS K6901 “Test methods for liquid unsaturated polyester resins.”

### (Hydroxyl Value)

Determined according to Section 6.4 “Hydroxyl number” of JIS K1557 “Polyols for use in the production of polyurethane.”

### (Isocyanate Group Content)

Determined according to Section 6.3 “Isocyanate group content” of JIS K7301 “Testing methods for tolylene diisocyanate type prepolymers for thermosetting urethane elastomers.”

### (Melt Viscosity)

Determined using a cone-and-plate rotational viscometer (manufactured by ICI) on the conditions of a cone type of 100P; a rotation speed of 75 rpm; and a temperature of 100° C. (determined at 40° C. in the case of low viscosity).

### (Number Average Molecular Weight)

A sample (0.03 g) was dissolved in 10 ml of tetrahydrofuran at room temperature, filtered with a filter having a pore size of 0.45 μm, and thereafter measured with a gel permeation chromatograph (GPC) on the following conditions. As for the number average molecular weight, a number average molecular weight from a peak including the molecular weight (retention time) at the highest peak in the measured chromatogram was calculated based on a calibration curve prepared using standard polyethylene glycol.

Apparatus: HLC-8020 (manufactured by TOSOH CORP.)

Column: Manufactured by TOSOH CORP., TSK gel guard column HXL-L+G1000H XL+G2000H XL+G3000H XL

Eluent: Tetrahydrofuran

Flow rate: 0.8 ml/min

Column temperature: 40° C.

Injection volume: 20 μl

Detector: RI

### (Amide Conversion)

Calculated by NMR on the following conditions.

Apparatus: JNM-AL400 (manufactured by JEOL)

Frequency: 400 MHz

Measurement temperature: Room temperature

Number of integrations: 128 times

### (1) Measuring Method of Polyester Polyamide Polycarboxylic Acid

A sample (20 mg) was dissolved in 0.65 ml of dimethyl sulfoxide-d6 (containing 0.05% TMS) at room temperature, and then ¹H-NMR was measured on the above conditions. The amide conversion was calculated from the integral for the proton (H) of the isocyanate derivative and the integral for the proton (NH) in the amide.

### (2) Measuring Method (Alkoxysilane Modification Ratio) of Alkoxysilane-Containing Resin

### (Raw Material: Polyester Polyamide Polycarboxylic Acid)

A sample (20 mg) was dissolved in 0.65 ml of dimethyl sulfoxide-d6 (containing 0.05% TMS) at room temperature, and then ¹H-NMR was measured on the above conditions. The amide conversion (alkoxysilane modification ratio) was calculated from the integral for the proton (H) of the isocyanato alkoxysilane compound derivative and the integral for the proton (NH) in the amide.

### (3) Measuring Method (Alkoxysilane Modification Ratio) of Alkoxysilane-Containing Resin

### (Raw Material: Dimer Acid, Amide-Modified Dimer Acid)

The amount of carbon dioxide generated was obtained from the reduced weight of the reaction mass after the reaction relative to the total charged amount, and the amide conversion was calculated from the following equation.

(Total charged amount−Weight of reaction mass after reaction)/[(Amount of dimer acid (amide-modified dimer acid) charged/COOH equivalent weight of dimer acid (amide-modified dimer acid) charged)×44]×100 (%)

### (Unreacted Acrylic Monomers)

After completion of the reaction, unreacted acrylic ester (C1-C20) compound (A) and/or unreacted acrylsilane compound (B) in the modified polyester before removing unreacted acrylic monomers were analyzed on the following conditions using a gas chromatograph, so that the unreacted acrylic monomer in each of those compounds was quantified.

Apparatus: GC-14A (manufactured by Shimadzu Corporation)

Carrier gas: Helium

Carrier gas flow rate: 30 ml/min

Column: 2 m×3 mm (p glass column

Filler: 10%-PEG-20 M Chromosorb WAW DMCS 80/100 mesh

Column temperature conditions: Maintained at 90° C. for 6 minutes, subsequently increased by 20° C./min, and maintained at 200° C. for 10 minutes.

RANGE: 101

Injection volume: 2 μl

Detector: FID

### (Content of Acrylic Polymer)

An acrylic monomer conversion was obtained from the unreacted acrylic monomer, which has been quantified by the above method, in the acrylic ester (C1-C20) compound (A) and/or the acrylsilane compound (B), and the acrylic polymer content was calculated from the following equation:

(Acrylic polymer content)=(Amount of (A) charged×Conversion of (A)+Amount of (B) charged×Conversion of (B))/(Total charged amount other than that of alkyl peroxide−Amount of unreacted acrylic monomer in (A)−Amount of unreacted acrylic monomer in (B))×100 (%)

### (Heat Resistance)

The dynamic viscoelasticity test was conducted on the following conditions, and the temperature (softening initiation temperature) at the time when a rapid reduction of the storage modulus (E′) value started was measured.

Apparatus: Dynamic viscoelasticity measuring apparatus DVA-200 (manufactured by IT MEASUREMENT CONTROL Co., Ltd.)

Sample: Gauge length: 2.5 cm, gauge width: 0.485 cm

Deformation mode: Tension

Static/Dynamic stress ratio: 1.8 to 2.0

Specified distortion: 0.05 to 0.10% (E>108 Pa)

Specified heating rate: 5° C./min

Measurement frequency: 10 Hz

### (Tensile Strength)

Determined according to Section 5 “Tension test” of JIS K7312 “Physical testing methods for molded products of thermosetting polyurethane elastomers.”

Device: Tensile strength testing machine RTA-500L-XL (manufactured by ORIENTEC Co., Ltd.)

Dumbbell: Dumbbell No. 4 type

Thickness: 0.5 to 0.8 mm

Temperature: 23° C.

Humidity: 50% RH

Test speed: 300 mm/min

### Synthesis Example 1

### Production of Polyester Polycarboxylic Acid (A)

A 5-liter flask equipped with a reflux condenser, a water separator, a nitrogen gas inlet tube, a thermometer, and a stirrer was charged with 2045.1 parts by weight of adipic acid and 1306.5 parts by weight of neopentyl glycol (the COOH/OH equivalent ratio: 1.12), and heated with a mantle heater while introducing nitrogen.

When the temperature reached 150° C., water started distilling off, and the flask was then heated up to 230° C. while distilling water. Thereafter, the dehydration condensation was continued at 230° C. When the acid and hydroxyl values of the reaction product reached their predetermined values, the reaction product was taken from the flask and then cooled, to produce a polyester polycarboxylic acid (A). The polyester polycarboxylic acid (A) thus produced had an acid value of 53.7 mg KOH/g and a hydroxyl value of 0.4 mg KOH/g.

### Synthesis Example 2

### Production of Polyester Polycarboxylic Acid (B)

A 5-liter flask equipped with a reflux condenser, a water separator, a nitrogen gas inlet tube, a thermometer, and a stirrer was charged with 2146.9 parts by weight of sebacic acid and 1083.0 parts by weight of 1,6-hexandiol (the COOH/OH equivalent ratio: 1.16), and heated with a mantle heater while introducing nitrogen.

When the temperature reached 150° C., water started distilling off, and the flask was then heated up to 230° C. while distilling water. Thereafter, the dehydration condensation was continued at 230° C. When the acid and hydroxyl values of the reaction product reached their predetermined values, the reaction product was taken from the flask and then cooled, to produce a polyester polycarboxylic acid (B). The polyester polycarboxylic acid (B) thus produced had an acid value of 57.9 mg KOH/g and a hydroxyl value of 0.1 mg KOH/g or less.

### Synthesis Example 3

### Production of Polyester Polycarboxylic Acid (C)

A 1-liter reaction flask equipped with a reflux condenser, a dropping funnel provided with a nitrogen gas inlet tube, a thermometer, and a stirrer was charged with 220.0 parts by weight of DYNACOLL 7150 (manufactured by Degussa, aromatic polyester polyol, hydroxyl value: 43.9 mg KOH/g), 330.0 parts by weight of polyester polycarboxylic acid (A), and 1.70 parts by weight of dimethyl aminopyridine, and heated up to 120° C. with a mantle heater while introducing nitrogen.

Thereafter, 18.1 parts by weight of succinic anhydride was added thereto, and the reaction was then continued at 120° C. for 8 hours, to produce a polyester polycarboxylic acid (C).

The polyester polycarboxylic acid (C) thus produced had an acid value of 54.2 mg KOH/g, a viscosity of 3800 mPa·s/100° C., and a number average molecular weight of 4200.

### Synthesis Example 4

### Production of Polyester Polycarboxylic Acid (D)

A 1-liter reaction flask equipped with a reflux condenser, a dropping funnel provided with a nitrogen gas inlet tube, a thermometer, and a stirrer was charged with 220.0 parts by weight of DYNACOLL 7140 (manufactured by Degussa, aromatic polyester polyol, hydroxyl value: 20.4 mg KOH/g), 330.0 parts by weight of polyester polycarboxylic acid (A), and 1.68 parts by weight of dimethyl aminopyridine, and heated up to 120° C. with a mantle heater while introducing nitrogen.

Thereafter, 8.41 parts by weight of succinic anhydride was added thereto, and the reaction was then continued at 120° C. for 8.5 hours, to produce a polyester polycarboxylic acid (D).

The polyester polycarboxylic acid (D) thus produced had an acid value of 43.2 mg KOH/g, a viscosity of 4300 mPa·s/100° C., and a number average molecular weight of 3700.

### Synthesis Example 5

### Production of Polyester Polyamide Polycarboxylic Acid (A)

A 3-liter reaction flask equipped with a reflux condenser, a dropping funnel provided with a nitrogen gas inlet tube, a thermometer, and a stirrer was charged with 1886.2 parts by weight of polyester polycarboxylic acid (A) and 1.000 part by weight of FLOWLEN AC-1190 (a defoaming agent, manufactured by Kyoeisha Chemical Co., Ltd.), and heated up to 200° C. with a mantle heater while introducing nitrogen.

Subsequently, 113.8 parts by weight of 4,4′-diphenylmethane diisocyanate (trade name: Cosmonate PH, manufactured by Mitsui Chemicals Polyurethanes, Inc., isocyanate group content: 33.6% by weight) (the COOHINCO equivalent ratio: 1.98) was added dropwise thereto at a uniform rate over 1 hour using the dropping funnel. After completion of the dropwise addition, the reaction was continued at 200° C. for 4 hours, to produce a polyester polyamide polycarboxylic acid (A).

The polyester polyamide polycarboxylic acid (A) thus produced had an isocyanate group content of 0.1% by weight or less, an acid value of 30.3 mg KOH/g, a viscosity of 5000 mPa·s/100° C., and a number average molecular weight of 4600.

The ¹H-NMR of the polyester polyamide polycarboxylic acid (A) produced was measured. Referring to the NMR chart, when the integral for 8 H of the benzene ring portion of the 4,4′-diphenylmethane diisocyanate derivative that appeared at a chemical shift of 7.0 to 7.5 ppm was determined to be 8.0000, the amide conversion was calculated from the integral for the amide 2NH that appeared at a chemical shift of 9.8 ppm. As a result, the amide conversion was found to be 92%.

### Synthesis Example 6

### Production of Polyester Polyamide Polycarboxylic Acid (B)

A 1-liter reaction flask equipped with a reflux condenser, a dropping funnel provided with a nitrogen gas inlet tube, a thermometer, and a stirrer was charged with 573.2 parts by weight of polyester polycarboxylic acid (A), 0.163 parts by weight of magnesium stearate (0.050 parts by mole per 100 parts by mole of the carboxyl group of the polyester polycarboxylic acid), and 0.300 parts by weight of FLOWLEN AC-1190 (a defoaming agent, manufactured by Kyoeisha Chemical Co., Ltd.), and heated up to 50° C. with a mantle heater while introducing nitrogen.

Subsequently, 26.8 parts by weight of 1,3-bis(isocyanatomethyl)cyclohexane (trade name: TAKENATE 600, manufactured by Mitsui Chemicals Polyurethanes, Inc., isocyanate content: 43.3% by weight) (the COOH/NCO equivalent ratio: 2.02) was added thereto using the dropping funnel. After the addition, the flask was heated to 70° C. and the reaction was continued for 3 hours. Further, the flask was heated to 90° C. and the reaction was continued for 4 hours, to produce a polyester polyamide polycarboxylic acid (B).

The polyester polyamide polycarboxylic acid (B) thus produced had an isocyanate group content of 0.2% by weight, an acid value of 30.8 mg KOH/g, a viscosity of 2300 mPa·s/100° C., and a number average molecular weight of 4000.

The ¹H-NMR of the polyester polyamide polycarboxylic acid (B) produced was measured. Referring to the NMR chart, when the integral of the 0.7346 H region appeared at a chemical shift of 0.6 ppm, in 10 H of the alicyclic portion of the 1,3-bis(isocyanatomethyl)cyclohexane derivative, was determined to be 0.7346, the amide conversion was calculated from the integral for the amide NH that appeared at a chemical shift of 7.8 ppm. As a result, the amide conversion was found to be 90%.

### Synthesis Example 7

### Production of Polyester Polyamide Polycarboxylic Acid (C)

A 1-liter reaction flask equipped with a reflux condenser, a dropping funnel provided with a nitrogen gas inlet tube, a thermometer, and a stirrer was charged with 565.9 parts by weight of polyester polycarboxylic acid (A) and 0.300 parts by weight of FLOWLEN AC-1190 (a defoaming agent, manufactured by Kyoeisha Chemical Co., Ltd.), and heated up to 200° C. with a mantle heater while introducing nitrogen.

Subsequently, 34.1 parts by weight of 4,4′-diphenylmethane diisocyanate (trade name: Cosmonate PH, manufactured by Mitsui Chemicals Polyurethanes, Inc.) was added dropwise thereto at a uniform rate over 20 minutes using the dropping funnel. After completion of the dropwise addition, the reaction was continued at 200° C. for 3 hours, to produce a polyester polyamide polycarboxylic acid (C).

The polyester polyamide polycarboxylic acid (C) thus produced had an isocyanate group content of 0.1% by weight or less, an acid value of 30.3 mg KOH/g, a viscosity of 4600 mPa·s/100° C., and a number average molecular weight of 4000.

The ¹H-NMR of the polyester polyamide polycarboxylic acid (C) produced was measured. Referring to the NMR chart, when the integral for 8 H of the benzene ring portion of the 4,4′-diphenylmethane diisocyanate derivative that appeared at a chemical shift of 7.0 to 7.5 ppm was determined to be 8.0000, the amide conversion was calculated from the integral for the amide 2 NH that appeared at a chemical shift of 9.8 ppm. As a result, the amide conversion was found to be 88%.

### Synthesis Example 8

### Production of Polyester Polyamide Polycarboxylic Acid (D)

A 1-liter reaction flask equipped with a reflux condenser, a dropping funnel provided with a nitrogen gas inlet tube, a thermometer, and a stirrer was charged with 235.4 parts by weight of polyester polycarboxylic acid (A), 235.4 parts by weight of polyester polycarboxylic acid (B), and 0.250 parts by weight of FLOWLEN AC-1190 (a defoaming agent, manufactured by Kyoeisha Chemical Co., Ltd.), and heated up to 200° C. with a mantle heater while introducing nitrogen.

Subsequently, 29.3 parts by weight of 4,4′-diphenylmethane diisocyanate (trade name: Cosmonate PH, manufactured by Mitsui Chemicals Polyurethanes, Inc.) was added dropwise thereto at a uniform rate over 10 minutes using the dropping funnel. After completion of the dropwise addition, the reaction was continued at 200° C. for 4 hours, to produce a polyester polyamide polycarboxylic acid (D).

The polyester polyamide polycarboxylic acid (D) thus produced had an isocyanate group content of 0.1% by weight or less, an acid value of 31.2 mg KOH/g, a viscosity of 5400 mPa·s/100° C., and a number average molecular weight of 4400.

The amide conversion was calculated from the amount of carbon dioxide that was obtained from the reduced weight of the reaction mass after the reaction relative to the total charged amount was 84%.

### Synthesis Example 9

### Production of Polyester Polyamide Polycarboxylic Acid (E)

A 1-liter reaction flask equipped with a reflux condenser, a dropping funnel provided with a nitrogen gas inlet tube, a thermometer, and a stirrer was charged with 147.1 parts by weight of polyester polycarboxylic acid (B), 147.1 parts by weight of polyester polycarboxylic acid (C), 0.087 parts by weight of magnesium stearate (0.050 parts by mole per 100 parts by mole of the carboxyl group of the polyester polycarboxylic acid), and 0.150 parts by weight of FLOWLEN AC-1190 (a defoaming agent, manufactured by Kyoeisha Chemical Co., Ltd.), and heated up to 120° C. with a mantle heater while introducing nitrogen.

Subsequently, 14.2 parts by weight of 1,3-bis(isocyanatomethyl)cyclohexane (trade name: TAKENATE 600, manufactured by Mitsui Chemicals Polyurethanes, Inc., isocyanate content: 43.3% by weight) was added dropwise thereto over 1 hour using the dropping funnel. After completion of the dropwise addition, the reaction was continued at a reaction temperature of 120° C. for 1.5 hours, to produce a polyester polyamide polycarboxylic acid (E).

The polyester polyamide polycarboxylic acid (E) thus produced had an acid value of 28.5 mg KOH/g, a viscosity of 3900 mPa·s/100° C., and a number average molecular weight of 5300.

The amide conversion was calculated from the amount of carbon dioxide that was obtained from the reduced weight of the reaction mass after the reaction relative to the total charged amount was 90%.

### Synthesis Example 10

### Production of Polyester Polyamide Polycarboxylic Acid (F)

A 1-liter reaction flask equipped with a reflux condenser, a dropping funnel provided with a nitrogen gas inlet tube, a thermometer, and a stirrer was charged with 150.7 parts by weight of polyester polycarboxylic acid (B), 150.7 parts by weight of polyester polycarboxylic acid (D), 0.080 parts by weight of magnesium stearate (0.050 parts by mole per 100 parts by mole of the carboxyl group of the polyester polycarboxylic acid), and 0.160 parts by weight of FLOWLEN AC-1190 (a defoaming agent, manufactured by Kyoeisha Chemical Co., Ltd.), and heated up to 120° C. with a mantle heater while introducing nitrogen.

Subsequently, 13.1 parts by weight of 1,3-bis(isocyanatomethyl)cyclohexane (trade name: TAKENATE 600, manufactured by Mitsui Chemicals Polyurethanes, Inc., isocyanate content: 43.3% by weight) was added dropwise thereto over 40 minutes using the dropping funnel. After completion of the dropwise addition, the reaction was continued at a reaction temperature of 120° C. for 2 hours, to produce a polyester polyamide polycarboxylic acid (F).

The polyester polyamide polycarboxylic acid (F) thus produced had an acid value of 26.9 mg KOH/g, a viscosity of 5100 mPa·s/100° C., and a number average molecular weight of 5900.

The amide conversion was calculated from the amount of carbon dioxide that was obtained from the reduced weight of the reaction mass after the reaction relative to the total charged amount was 97%.

### Synthesis Example 11

### Production of Amide-Modified Dimer Acid (A)

A 1-liter reaction flask equipped with a reflux condenser, a dropping funnel provided with a nitrogen gas inlet tube, a thermometer, and a stirrer was charged with 513.4 parts by weight of a hydrogenated high-purity dimer acid (trade name: PRIPOL1009, manufactured by Unichema, acid value: 196 mg KOH/g), 0.176 parts by weight of magnesium stearate (0.017 parts by mole per 100 parts by mole of the carboxyl group of the dimer acid), and 0.300 parts by weight of FLOWLEN AC-1190 (a defoaming agent, manufactured by Kyoeisha Chemical Co., Ltd.), and heated up to 75° C. with a mantle heater while introducing nitrogen.

Subsequently, 86.6 parts by weight of 1,3-bis(isocyanatomethyl)cyclohexane (trade name: TAKENATE 600, manufactured by Mitsui Chemicals Polyurethanes, Inc., isocyanate content: 43.3% by weight) (the COOH/NCO equivalent ratio: 2.01) was added thereto using the dropping funnel. After the addition, the flask was heated to 80° C. and the reaction was continued for 3 hours, to produce an amide-modified dimer acid (A).

The amide-modified dimer acid (A) thus produced had an isocyanate group content of 0.3% by weight, an acid value of 97.9 mg KOH/g, a viscosity of 2600 mPa·s/100° C., and a number average molecular weight of 1500.

The amide conversion was calculated from the amount of carbon dioxide generated that was obtained from the reduced weight of the reaction mass after the reaction relative to the total charged amount was 95%.

### Synthesis Example 12

### Production of Amide-Modified Dimer Acid (B)

A 2-liter reaction flask equipped with a reflux condenser, a dropping funnel provided with a nitrogen gas inlet tube, a thermometer, and a stirrer was charged with 979.7 parts by weight of a hydrogenated high-purity dimer acid (trade name: PRIPOL1009, manufactured by Unichema, acid value: 196 mg KOH/g), 0.336 parts by weight of magnesium stearate (0.017 parts by mole per 100 parts by mole of the carboxyl group of the dimer acid), and 0.600 parts by weight of FLOWLEN AC-1190 (a defoaming agent, manufactured by Kyoeisha Chemical Co., Ltd.), and heated up to 90° C. with a mantle heater while introducing nitrogen.

Subsequently, 220.3 parts by weight of 1,3-bis(isocyanatomethyl)cyclohexane (trade name: TAKENATE 600, manufactured by Mitsui Chemicals Polyurethanes, Inc., isocyanate content: 43.3% by weight) (the COOH/NCO equivalent ratio: 1.51) was added dropwise thereto over 1.5 hours using the dropping funnel. After completion of the dropwise addition, the reaction was continued for 9 hours, to produce an amide-modified dimer acid (B).

The amide-modified dimer acid (B) thus produced had an isocyanate group content of 0.4% by weight, an acid value of 68.6 mg KOH/g, a viscosity of 15600 mPa·s/100° C., and a number average molecular weight of 2600.

The amide conversion was calculated from the amount of carbon dioxide generated that was obtained from the reduced weight of the reaction mass after the reaction relative to the total charged amount was 95%.

### Synthesis Example 13

### Production of Polyester Polyol (A)

A 5-liter flask equipped with a reflux condenser, a water separator, a nitrogen gas inlet tube, a thermometer, and a stirrer was charged with 1623.99 parts by weight of adipic acid, 1342.55 parts by weight of neopentyl glycol (the OH/COOH equivalent ratio: 1.16), and 1.93 parts by weight of dibutyltin oxide, and heated with a mantle heater while introducing nitrogen.

When the temperature reached 150° C., water started distilling off, and the flask was then heated up to 230° C. while distilling water. Thereafter, the dehydration condensation was continued at 230° C. When the hydroxyl and acid values of the reaction product reached their predetermined values, the reaction product was taken from the flask and then cooled, to produce a polyester polyol (A). The polyester polyol (A) thus produced had a hydroxyl value of 53.5 mg KOH/g and an acid value of 0.6 mg KOH/g.

### Example 1

### (Production of Alkoxysilane-Containing Resin (A))

A 1-liter reaction flask equipped with a reflux condenser, a nitrogen gas inlet tube, a thermometer, and a stirrer was charged with 321.9 parts by weight of the polyester polycarboxylic acid (A), 0.092 parts by weight of magnesium stearate (0.050 parts by mole per 100 parts by mole of the carboxyl group of the polyester polycarboxylic acid), and 0.200 parts by weight of FLOWLEN AC-1190 (a defoaming agent, manufactured by Kyoeisha Chemical Co., Ltd.).

Subsequently, the flask was heated up to 70° C. with a mantle heater while introducing nitrogen. Then, 78.1 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using a dropping funnel. After completion of the dropwise addition, the reaction was continued at a reaction temperature of 70° C. for 12 hours, to produce an alkoxysilane-containing resin (A).

The alkoxysilane-containing resin (A) thus produced had an isocyanate group content of 0.1% by weight, an acid value of 6.9 mg KOH/g, a viscosity of 12200 mPa·s/40° C., and a number average molecular weight of 2600.

The ¹H-NMR of the alkoxysilane-containing resin (A) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 78%.

### (Production of Hot-Melt Adhesive Agent (A) and Cured Resin Product (A))

A plastic container was charged with 50 parts by weight of the alkoxysilane-containing resin (A), 0.5 parts by weight of stannous octoate, and 0.5 parts by weight of tetraethoxysilane, and was subjected to a vacuum defoaming treatment with a vacuum dryer at 100° C. for 30 minutes, to prepare a one-part moisture-curable hot-melt adhesive agent (A).

The hot-melt adhesive agent (A) was casted on an SUS plate, which an appropriate amount of a releasing agent MIRAX RS-102 (manufactured by Katsuzai Chemicals Corp.) was applied to a surface of and was heated to 100° C., so that the cured resin product after moisture-curing had a thickness of 0.7 to 2.2 mm. The casted product was then left to stand for 48 hours on the conditions of 23° C., 50% RH under air, and was moisture-cured over 48 hours on the conditions of 80° C., 30% RH under air, to produce a cured resin product (A).

When the heat resistance and tensile strength of the cured resin product (A) thus produced were determined by the above methods, the cured resin product (A) had a softening initiation temperature of 310° C. and a tensile strength of 0.74 MPa (cf. Table 1).

### Example 2

### (Production of Alkoxysilane-Containing Resin (B))

The same procedures as in Example 1 were carried out except that the reaction temperature was changed from 70° C. to 120° C. and the reaction time was changed from 12 hours to 5 hours, to produce an alkoxysilane-containing resin (B).

The alkoxysilane-containing resin (B) thus produced had an isocyanate group content of less than 0.1% by weight, an acid value of 7.7 mg KOH/g, a viscosity of 14800 mPa·s/40° C., and a number average molecular weight of 2600.

The ¹H-NMR of the alkoxysilane-containing resin (B) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 77%.

### (Production of Hot-Melt Adhesive Agent (B) and Cured Resin Product (B))

The same procedures as in Example 1 were carried out except that 50 parts by weight of the alkoxysilane-containing resin (B) was used in place of the alkoxysilane-containing resin (A), to prepare a hot-melt adhesive agent (B) and moisture-cure it, so that a cured resin product (B) was produced.

When the heat resistance and tensile strength of the cured resin product (B) thus produced were determined by the above methods, the cured resin product (B) had a softening initiation temperature of 320° C. and a tensile strength of 0.72 MPa (cf. Table 1).

### Example 3

### (Production of Alkoxysilane-Containing Resin (C))

The same procedures as in Example 1 were carried out except that the reaction temperature was changed from 70° C. to 130° C. and the reaction time was changed from 12 hours to 5 hours, to produce an alkoxysilane-containing resin (C).

The alkoxysilane-containing resin (C) thus produced had an isocyanate group content of less than 0.1% by weight, an acid value of 7.8 mg KOH/g, a viscosity of 16200 mPa·s/40° C., and a number average molecular weight of 2900.

The ¹H-NMR of the alkoxysilane-containing resin (C) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 76%.

### (Production of Hot-Melt Adhesive Agent (C) and Cured Resin Product (C))

The same procedures as in Example 1 were carried out except that 50 parts by weight of the alkoxysilane-containing resin (C) was used in place of the alkoxysilane-containing resin (A), to prepare a hot-melt adhesive agent (C) and moisture-cure it, so that a cured resin product (C) was produced.

When the heat resistance and tensile strength of the cured resin product (C) thus produced were determined by the above methods, the cured resin product (C) had a softening initiation temperature of 310° C. and a tensile strength of 0.70 MPa (cf. Table 1).

### Example 4

### (Production of Alkoxysilane-Containing Resin (D))

The same procedures as in Example 1 were carried out except that the reaction temperature was changed from 70° C. to 150° C. and the reaction time was changed from 12 hours to 3 hours, to produce an alkoxysilane-containing resin (D).

The alkoxysilane-containing resin (D) thus produced had an isocyanate group content of less than 0.1% by weight, an acid value of 9.6 mg KOH/g, a viscosity of 16300 mPa·s/40° C., and a number average molecular weight of 2800.

The ¹H-NMR of the alkoxysilane-containing resin (D) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 74%.

### (Production of Hot-Melt Adhesive Agent (D) and Cured Resin Product (D))

The same procedures as in Example 1 were carried out except that 50 parts by weight of the alkoxysilane-containing resin (D) was used in place of the alkoxysilane-containing resin (A), to prepare a hot-melt adhesive agent (D) and moisture-cure it, so that a cured resin product (D) was produced.

When the heat resistance and tensile strength of the cured resin product (D) thus produced were determined by the above methods, the cured resin product (D) had a softening initiation temperature of 310° C. and a tensile strength of 0.65 MPa (cf. Table 1).

### Example 5

### (Production of Alkoxysilane-Containing Resin (E))

A 1-liter reaction flask equipped with a reflux condenser, a nitrogen gas inlet tube, a thermometer, and a stirrer was charged with 476.2 parts by weight of the polyester polycarboxylic acid (B), 0.145 parts by weight of magnesium stearate (0.050 parts by mole per 100 parts by mole of the carboxyl group of the polyester polycarboxylic acid), and 0.300 parts by weight of FLOWLEN AC-1190 (a defoaming agent, manufactured by Kyoeisha Chemical Co., Ltd.).

Subsequently, the flask was heated up to 100° C. with a mantle heater while introducing nitrogen. Then, 123.8 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using a dropping funnel. After completion of the dropwise addition, the reaction was continued at a reaction temperature of 100° C. for 5 hours, to produce an alkoxysilane-containing resin (E).

The alkoxysilane-containing resin (E) thus produced had an isocyanate group content of 0.3% by weight, an acid value of 6.8 mg KOH/g, a viscosity of 400 mPa·s/100° C., and a number average molecular weight of 2800.

The amide conversion was calculated from the amount of carbon dioxide that was obtained from the reduced weight of the reaction mass after the reaction relative to the total charged amount was 91%.

### (Production of Hot-Melt Adhesive Agent (E) and Cured Resin Product (E))

A plastic container was charged with 40 parts by weight of the alkoxysilane-containing resin (A), 40 parts by weight of the alkoxysilane-containing resin (E), 0.8 parts by weight of stannous octoate, 0.8 parts by weight of tetraethoxysilane, 2.49 parts by weight of γ-aminopropyl triethoxysilane (trade name: KBE903, manufactured by Shin-Etsu Chemical Co., Ltd.), and 2.31 parts by weight of N-β-(aminoethyl)-γ-aminopropyl trimethoxysilane (trade name: KBM603, manufactured by Shin-Etsu Chemical Co., Ltd.), and was subjected to a vacuum defoaming treatment with a vacuum dryer at 100° C. for 30 minutes, to prepare a one-part moisture-curable hot-melt adhesive agent (E).

The hot-melt adhesive agent (E) was casted on an SUS plate, which an appropriate amount of a releasing agent MIRAX RS-102 (manufactured by Katsuzai Chemicals Corp.) was applied to a surface of and was heated to 100° C., so that the cured resin product after moisture-curing had a thickness of 0.7 to 2.0 mm. The casted product was then left to stand for 48 hours on the conditions of 23° C., 50% RH under air, and was moisture-cured over 48 hours on the conditions of 80° C., 30% RH under air, to produce a cured resin product (E).

When the heat resistance and tensile strength of the cured resin product (E) thus produced were determined by the above methods, the cured resin product (E) had a softening initiation temperature of 280° C. and a tensile strength of 3.50 MPa (cf. Table 1).

### Example 6

### (Production of Alkoxysilane-Containing Resin (F))

A 3-liter reaction flask equipped with a reflux condenser, a dropping funnel provided with a nitrogen gas inlet tube, a thermometer, and a stirrer was charged with 1949.8 parts by weight of a polyester polyamide polycarboxylic acid (A) and 0.312 parts by weight of magnesium stearate (0.050 parts by mole per 100 parts by mole of the carboxyl group of the polyester polyamide polycarboxylic acid), and heated up to 120° C. with a mantle heater while introducing nitrogen.

Subsequently, 265.4 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued at a reaction temperature of 120° C. for 6 hours, to produce an alkoxysilane-containing resin (F).

The alkoxysilane-containing resin (F) thus produced had an isocyanate group content of 0.1% by weight, an acid value of 3.2 mg KOH/g, a viscosity of 5800 mPa·s/100° C., and a number average molecular weight of 5700.

The ¹H-NMR of the alkoxysilane-containing resin (F) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 90%.

### (Production of Hot-Melt Adhesive Agent (F) and Cured Resin Product (F))

A plastic container was charged with 80 parts by weight of the alkoxysilane-containing resin (F), 0.8 parts by weight of stannous octoate, and 0.8 parts by weight of tetraethoxysilane, and was subjected to a vacuum defoaming treatment with a vacuum dryer at 100° C. for 30 minutes, to prepare a one-part moisture-curable hot-melt adhesive agent (F).

The hot-melt adhesive agent (F) was casted on an SUS plate, which an appropriate amount of a releasing agent MIRAX RS-102 (manufactured by Katsuzai Chemicals Corp.) was applied to a surface of and was heated to 100° C., so that the cured resin product after moisture-curing had a thickness of 0.7 to 2.2 mm. The casted product was then left to stand for 48 hours on the conditions of 23° C., 50% RH under air, and was moisture-cured over 48 hours on the conditions of 80° C., 30% RH under air, to produce a cured resin product (F).

When the heat resistance and tensile strength of the cured resin product (F) thus produced were determined by the above methods, the cured resin product (F) had a softening initiation temperature of 280° C. and a tensile strength of 1.92 MPa (cf. Table 2).

### Example 7

### (Production of Alkoxysilane-Containing Resin (G))

A 1-liter reaction flask equipped with a reflux condenser, a dropping funnel provided with a nitrogen gas inlet tube, a thermometer, and a stirrer was charged with 550.5 parts by weight of a polyester polyamide polycarboxylic acid (B) and heated up to 80° C. with a mantle heater while introducing nitrogen.

Subsequently, 76.0 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued for 7 hours, to produce an alkoxysilane-containing resin (G).

The alkoxysilane-containing resin (G) thus produced had an isocyanate group content of 0.3% by weight, an acid value of 1.9 mg KOH/g, a viscosity of 2200 mPa·s/100° C., and a number average molecular weight of 4200.

The ¹H-NMR of the alkoxysilane-containing resin (G) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 89%.

### (Production of Hot-Melt Adhesive Agent (G) and Cured Resin Product (G))

The same procedures as in Example 6 were carried out except that 80 parts by weight of the alkoxysilane-containing resin (G) was used in place of the alkoxysilane-containing resin (F), to prepare a hot-melt adhesive agent (G) and moisture-cure it, so that a cured resin product (G) was produced.

When the heat resistance and tensile strength of the cured resin product (G) thus produced were determined by the above methods, the cured resin product (G) had a softening initiation temperature of 280° C. and a tensile strength of 1.45 MPa (cf. Table 2).

### Example 8

### (Production of Alkoxysilane-Containing Resin (H))

A 1-liter reaction flask equipped with a reflux condenser, a dropping funnel provided with a nitrogen gas inlet tube, a thermometer, and a stirrer was charged with 481.0 parts by weight of a polyester polyamide polycarboxylic acid (D) and 0.079 parts by weight of magnesium stearate (0.050 parts by mole per 100 parts by mole of the carboxyl group of the polyester polyamide polycarboxylic acid), and heated up to 130° C. with a mantle heater while introducing nitrogen.

Subsequently, 122.7 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued at a reaction temperature of 130° C. for 5 hours, to produce an alkoxysilane-containing resin (H).

The alkoxysilane-containing resin (H) thus produced had an isocyanate group content of 0.3% by weight, an acid value of 4.9 mg KOH/g, a viscosity of 7300 mPa·s/100° C., and a number average molecular weight of 5500.

The amide conversion was calculated from the amount of carbon dioxide that was obtained from the reduced weight of the reaction mass after the reaction relative to the total charged amount was 89%.

### (Production of Hot-Melt Adhesive Agent (H) and Cured Resin Product (H))

A plastic container was charged with 80 parts by weight of the alkoxysilane-containing resin (H), 0.8 parts by weight of stannous octoate, 0.8 parts by weight of tetraethoxysilane, 2.49 parts by weight of γ-aminopropyl triethoxysilane (trade name: KBE903, manufactured by Shin-Etsu Chemical Co., Ltd.), and 2.31 parts by weight of N-β-(aminoethyl)-γ-aminopropyl trimethoxysilane (trade name: KBM603, manufactured by Shin-Etsu Chemical Co., Ltd.), and was subjected to a vacuum defoaming treatment with a vacuum dryer at 100° C. for 30 minutes, to prepare a one-part moisture-curable hot-melt adhesive agent (H).

The hot-melt adhesive agent (H) was casted on an SUS plate, which an appropriate amount of a releasing agent MIRAX RS-102 (manufactured by Katsuzai Chemicals Corp.) was applied to a surface of and was heated to 100° C., so that the cured resin product after moisture-curing had a thickness of 0.7 to 2.0 mm. The casted product was then left to stand for 48 hours on the conditions of 23° C., 50% RH under air, and was moisture-cured over 48 hours on the conditions of 80° C., 30% RH under air, to produce a cured resin product (H).

When the heat resistance and tensile strength of the cured resin product (H) thus produced were determined by the above methods, the cured resin product (H) had a softening initiation temperature of 270° C. and a tensile strength of 4.71 MPa (cf. Table 2).

### Example 9

### (Production of Alkoxysilane-Containing Resin (I))

A 1-liter reaction flask equipped with a reflux condenser, a dropping funnel provided with a nitrogen gas inlet tube, a thermometer, and a stirrer was charged with 293.0 parts by weight of a polyester polyamide polycarboxylic acid (E) and heated up to 120° C. with a mantle heater while introducing nitrogen.

Subsequently, 37.4 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued at a reaction temperature of 120° C. for 3.5 hours, to produce an alkoxysilane-containing resin (I).

The alkoxysilane-containing resin (I) thus produced had an isocyanate group content of 0.1% by weight or less, an acid value of 5.6 mg KOH/g, a viscosity of 6700 mPa·s/100° C., and a number average molecular weight of 6900.

The amide conversion was calculated from the amount of carbon dioxide that was obtained from the reduced weight of the reaction mass after the reaction relative to the total charged amount was 88%.

### (Production of Hot-Melt Adhesive Agent (I) and Cured Resin Product (I))

The same procedures as in Example 8 were carried out except that 80 parts by weight of the alkoxysilane-containing resin (I) was used in place of the alkoxysilane-containing resin (H), to prepare a hot-melt adhesive agent (I) and moisture-cure it, so that a cured resin product (I) was produced.

When the heat resistance and tensile strength of the cured resin product (I) thus produced were determined by the above methods, the cured resin product (I) had a softening initiation temperature of 260° C. and a tensile strength of 6.52 MPa (cf. Table 2).

### Example 10

### (Production of Alkoxysilane-Containing Resin (J))

A 1-liter reaction flask equipped with a reflux condenser, a dropping funnel provided with a nitrogen gas inlet tube, a thermometer, and a stirrer was charged with 296.4 parts by weight of a polyester polyamide polycarboxylic acid (F) and heated up to 120° C. with a mantle heater while introducing nitrogen.

Subsequently, 35.8 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1.5 hours using the dropping funnel. After completion of the dropwise addition, the reaction was continued at a reaction temperature of 120° C. for 2.5 hours, to produce an alkoxysilane-containing resin (J).

The alkoxysilane-containing resin (J) thus produced had an isocyanate group content of 0.1% by weight or less, an acid value of 5.5 mg KOH/g, a viscosity of 11000 mPa·s/100° C., and a number average molecular weight of 6500.

The amide conversion was calculated from the amount of carbon dioxide that was obtained from the reduced weight of the reaction mass after the reaction relative to the total charged amount was 77%.

### (Production of Hot-Melt Adhesive Agent (J) and Cured Resin Product (J))

The same procedures as in Example 8 were carried out except that 80 parts by weight of the alkoxysilane-containing resin (J) was used in place of the alkoxysilane-containing resin (H), to prepare a hot-melt adhesive agent (J) and moisture-cure it, so that a cured resin product (J) was produced.

When the heat resistance and tensile strength of the cured resin product (J) thus produced were determined by the above methods, the cured resin product (J) had a softening initiation temperature of 270° C. and a tensile strength of 7.28 MPa (cf. Table 2).

### Example 11

### (Production of Alkoxysilane-Containing Resin (K))

A 1-liter reaction flask equipped with a reflux condenser, a nitrogen gas inlet tube, a thermometer, and a stirrer was charged with 266.6 parts by weight of a hydrogenated high-purity dimer acid (trade name: PRIPOL1009, manufactured by Unichema, acid value: 196 mg KOH/g), 0.092 parts by weight of magnesium stearate (0.017 parts by mole per 100 parts by mole of the carboxyl group of the dimer acid), and 0.250 parts by weight of FLOWLEN AC-1190 (a defoaming agent, manufactured by Kyoeisha Chemical Co., Ltd.).

Subsequently, the flask was heated up to 70° C. with a mantle heater while introducing nitrogen. Then, 233.4 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued at a reaction temperature of 70° C. for 7 hours, to produce an alkoxysilane-containing resin (K).

The alkoxysilane-containing resin (K) thus produced had an isocyanate group content of 0.4% by weight, an acid value of 16.0 mg KOH/g, a viscosity of 2040 mPa·s/40° C., and a number average molecular weight of 1100.

The amide conversion was calculated from the amount of carbon dioxide generated that was obtained from the reduced weight of the reaction mass after the reaction relative to the total charged amount was 87%.

### (Production of Hot-Melt Adhesive Agent (K) and Cured Resin Product (K))

The same procedures as in Example 1 were carried out except that 50 parts by weight of the alkoxysilane-containing resin (K) was used in place of the alkoxysilane-containing resin (A), to prepare a hot-melt adhesive agent (K) and moisture-cure it, so that a cured resin product (K) was produced.

When the heat resistance and tensile strength of the cured resin product (K) thus produced were determined by the above methods, the cured resin product (K) had a softening initiation temperature of 300° C. and a tensile strength of 5.80 MPa (cf. Table 3).

### Example 12

### (Production of Alkoxysilane-Containing Resin (L))

A 1-liter reaction flask equipped with a reflux condenser, a dropping funnel provided with a nitrogen gas inlet tube, a thermometer, and a stirrer was charged with 546.7 parts by weight of an amide-modified dimer acid (A) and heated up to 80° C. with a mantle heater while introducing nitrogen.

Subsequently, 252.5 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.05) was added dropwise thereto over 4 hours using the dropping funnel. After completion of the dropwise addition, the flask was heated to 90° C. and the reaction was continued for 3 hours, to produce an alkoxysilane-containing resin (L).

The alkoxysilane-containing resin (L) thus produced had an isocyanate group content of 0.5% by weight, an acid value of 8.8 mg KOH/g, a viscosity of 1000 mPa·s/100° C., and a number average molecular weight of 2000.

The amide conversion was calculated from the amount of carbon dioxide generated that was obtained from the reduced weight of the reaction mass after the reaction relative to the total charged amount was 83%.

### (Production of Hot-Melt Adhesive Agent (L) and Cured Resin Product (L))

The same procedures as in Example 1 were carried out except that 50 parts by weight of the alkoxysilane-containing resin (L) was used in place of the alkoxysilane-containing resin (A), to prepare a hot-melt adhesive agent (L) and moisture-cure it, so that a cured resin product (L) was produced.

When the heat resistance and tensile strength of the cured resin product (L) thus produced were determined by the above methods, the cured resin product (L) had a softening initiation temperature of 300° C. and a tensile strength of 15.7 MPa (cf. Table 3).

### Example 13

### (Production of Alkoxysilane-Containing Resin (M))

A 1-liter reaction flask equipped with a reflux condenser, a dropping funnel provided with a nitrogen gas inlet tube, a thermometer, and a stirrer was charged with 206.3 parts by weight of an amide-modified dimer acid (B) and heated up to 100° C. with a mantle heater while introducing nitrogen.

Subsequently, 63.5 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued at a reaction temperature of 100° C. for 3 hours, to produce an alkoxysilane-containing resin (M).

The alkoxysilane-containing resin (M) thus produced had an isocyanate group content of 0.3% by weight, an acid value of 7.8 mg KOH/g, a viscosity of 6000 mPa·s/100° C., and a number average molecular weight of 2600.

The amide conversion was calculated from the amount of carbon dioxide generated that was obtained from the reduced weight of the reaction mass after the reaction relative to the total charged amount was 91%.

### (Production of Hot-Melt Adhesive Agent (M) and Cured Resin Product (M))

The same procedures as in Example 1 were carried out except that 50 parts by weight of the alkoxysilane-containing resin (M) was used in place of the alkoxysilane-containing resin (A), to prepare a hot-melt adhesive agent (M) and moisture-cure it, so that a cured resin product (M) was produced.

When the heat resistance and tensile strength of the cured resin product (M) thus produced were determined by the above methods, the cured resin product (M) had a softening initiation temperature of 300° C. and a tensile strength of 18.3 MPa (cf. Table 3).

### Comparative Example 1

### (Production of Alkoxysilane-Containing Resin (N))

A 1-liter reaction flask equipped with a reflux condenser, a dropping funnel provided with a nitrogen gas inlet tube, a thermometer, and a stirrer was charged with 110.0 parts by weight of a polyester polyol (A) and heated up to 75° C. with a mantle heater while introducing nitrogen.

Subsequently, 26.7 parts by weight of γ-isocyanatopropyl triethoxysilane (trade name: KBE9007, manufactured by Shin-Etsu Chemical Co., Ltd., isocyanate group content: 16.7% by weight) (the NCO/OH equivalent ratio: 1.00) was added dropwise thereto at a uniform rate over 1 hour using the dropping funnel. After completion of the dropwise addition, the reaction was continued at a reaction temperature of 75° C. for 3 hours, to produce an alkoxysilane-containing resin (N).

The alkoxysilane-containing resin (N) thus produced had an isocyanate group content of 0.1% by weight or less, a viscosity of 7600 mPa·s/40° C., and a number average molecular weight of 3300.

### (Production of Hot-Melt Adhesive Agent (N) and Cured Resin Product (N))

The same procedures as in Example 6 were carried out except that 80 parts by weight of the alkoxysilane-containing resin (N) was used in place of the alkoxysilane-containing resin (F), to prepare a hot-melt adhesive agent (N) and moisture-cure it, so that a cured resin product (N) was produced.

When the heat resistance of the cured resin product (N) thus produced was determined by the above method, the cured resin product (N) had a softening initiation temperature of 220° C. (cf. Table 3).

### Comparative Example 2

### (Production of Alkoxysilane-Containing Resin (O))

A 1-liter reaction flask equipped with a reflux condenser, a nitrogen gas inlet tube, a thermometer, and a stirrer was charged with 263.5 parts by weight of dimer diol (hydroxyl value: 200 mg KOH/g) and 0.100 parts by weight of stannous octoate, and heated up to 80° C. with a mantle heater while introducing nitrogen.

Subsequently, 236.5 parts by weight of γ-isocyanatopropyl triethoxysilane (trade name: KBE9007, manufactured by Shin-Etsu Chemical Co., Ltd., isocyanate group content: 16.7% by weight) (the NCO/OH equivalent ratio: 1.00) was added dropwise over 1 hour using a dropping funnel. After completion of the dropwise addition, the reaction was continued for 4 hours, to produce an alkoxysilane-containing resin (O).

The alkoxysilane-containing resin (O) thus produced had an isocyanate group content of 0.1 % by weight or less.

### (Production of Hot-Melt Adhesive Agent (O) and Cured Resin Product (O))

The same procedures as in Example 1 were carried out except that 50 parts by weight of the alkoxysilane-containing resin (O) was used in place of the alkoxysilane-containing resin (A), to prepare a hot-melt adhesive agent (O) and moisture-cure it, so that a cured resin product (O) was produced.

When the heat resistance of the cured resin product (O) thus produced was determined by the above method, the cured resin product (O) had a softening initiation temperature of 210° C. (cf. Table 3).

### Example 14

### (Production of Alkoxysilane-Containing Resin (P))

A 5-liter reaction flask equipped with a reflux condenser, a nitrogen gas inlet tube, a thermometer, and a stirrer was charged with 1850.7 parts by weight of the polyester polycarboxylic acid (A), 0.528 parts by weight of magnesium stearate (0.050 parts by mole per 100 parts by mole of the carboxyl group of the polyester polycarboxylic acid), and 1.150 parts by weight of FLOWLEN AC-1190 (a defoaming agent, manufactured by Kyoeisha Chemical Co., Ltd.).

Subsequently, the flask was heated up to 70° C. with a mantle heater while introducing nitrogen. Then, 449.3 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.01) was added dropwise over 1 hour using a dropping funnel. After completion of the dropwise addition, the reaction was continued at a reaction temperature of 70° C. for 7 hours, to produce an alkoxysilane-containing resin (P).

The alkoxysilane-containing resin (P) thus produced had an isocyanate group content of 0.3% by weight, an acid value of 7.7 mg KOH/g, a viscosity of 10900 mPa·s/40° C., and a number average molecular weight of 3000.

The ¹H-NMR of the alkoxysilane-containing resin (P) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 76%.

### (Production of Modified Alkoxysilane-Containing Resin (A))

A 500-milliliter reaction flask equipped with a reflux condenser, a dropping funnel provided with a nitrogen gas inlet tube, a thermometer, and a stirrer was charged with 269.7 parts by weight of an alkoxysilane-containing resin (P) and heated up to 120° C. with a mantle heater while introducing nitrogen.

Next, a solution obtained by homogeneously mixing 32.3 parts by weight of γ-methacryloxypropyl trimethoxysilane (trade name: LS3380, manufactured by Shin-Etsu Chemical Co., Ltd.) and 98.0 parts by weight of n-butyl methacrylate, and 24.2 parts by weight of PERHEXA C (a reaction initiator manufactured by NOF Corporation, 70% by weight of hydrocarbon solution of 1,1-bis(t-butylperoxy)cyclohexane) was added dropwise to the above-mentioned flask at a uniform rate over 4 hours using the dropping funnel.

After completion of the dropwise addition, the reaction was continued at 120° C. for 4 hours. Subsequently, the unreacted γ-methacryloxypropyl trimethoxysilane and n-butyl methacrylate were analyzed by a gas chromatograph and their acrylic monomer conversions were determined. As a result, the acrylic monomer conversions of the γ-methacryloxypropyl trimethoxysilane and the n-butyl methacrylate were found to be 90.2% by weight and 90.8% by weight, respectively. After completion of the reaction, the reaction solution was subjected to pressure reduction for 4 hours on the conditions of 120° C., 1.3 kPa or less, and the unreacted acrylic monomers were removed, to produce a modified alkoxysilane-containing resin (A).

The modified alkoxysilane-containing resin (A) thus produced had a viscosity of 1500 mPa·s/100° C., an acrylic polymer content of 30.5%, and a number average molecular weight of 3600.

### (Production of Hot-Melt Adhesive Agent (P) and Cured Resin Product (P))

A plastic container was charged with 80 parts by weight of the modified alkoxysilane-containing resin (A), 0.8 parts by weight of stannous octoate, 0.8 parts by weight of tetraethoxysilane, 2.49 parts by weight of γ-aminopropyl triethoxysilane (trade name: KBE903, manufactured by Shin-Etsu Chemical Co., Ltd.), and 2.31 parts by weight of N-β-(aminoethyl)-γ-aminopropyl trimethoxysilane (trade name: KBM603, manufactured by Shin-Etsu Chemical Co., Ltd.), and was subjected to a vacuum defoaming treatment with a vacuum dryer at 100° C. for 30 minutes, to prepare a one-part moisture-curable hot-melt adhesive agent (P).

The hot-melt adhesive agent (P) was casted on an SUS plate, which an appropriate amount of a releasing agent MIRAX RS- 102 (manufactured by Katsuzai Chemicals Corp.) was applied to a surface of and was heated to 100° C., so that the cured resin product after moisture-curing had a thickness of 0.7 to 2.0 mm. The casted product was then left to stand for 48 hours on the conditions of 23° C., 50% RH under air, and was moisture-cured over 48 hours on the conditions of 80° C., 30% RH under air, to produce a cured resin product (P).

When the heat resistance and tensile strength of the cured resin product (P) thus produced were determined by the above methods, the cured resin product (P) had a softening initiation temperature of 280° C. and a tensile strength of 2.78 MPa (cf. Table 4).

### Example 15

### (Production of Modified Alkoxysilane-Containing Resin (B))

A 500-milliliter reaction flask equipped with a reflux condenser, a dropping funnel provided with a nitrogen gas inlet tube, a thermometer, and a stirrer was charged with 250.0 parts by weight of an alkoxysilane-containing resin (P) and heated up to 120° C. with a mantle heater while introducing nitrogen.

Next, a solution obtained by homogeneously mixing 30.0 parts by weight of γ-methacryloxypropyl trimethoxysilane (trade name: LS3380, manufactured by Shin-Etsu Chemical Co., Ltd.) and 22.5 parts by weight of PERHEXA C (a reaction initiator manufactured by NOF Corporation, 70% by weight of hydrocarbon solution of 1,1-bis(t-butylperoxy)cyclohexane) was added dropwise to the above-mentioned flask at a uniform rate over 4 hours using the dropping funnel.

After completion of the dropwise addition, the reaction was continued at 120° C. for 4 hours. Subsequently, the unreacted γ-methacryloxypropyl trimethoxysilane was analyzed by a gas chromatograph and its acrylic monomer conversion was determined. As a result, the acrylic monomer conversion of the γ-methacryloxypropyl trimethoxysilane was found to be 99.2% by weight. After completion of the reaction, the reaction solution was subjected to pressure reduction for 4 hours on the conditions of 120° C., 1.3 kPa or less, and the unreacted acrylic monomers were removed, to produce a modified alkoxysilane-containing resin (B).

The modified alkoxysilane-containing resin (B) thus produced had a viscosity of 1280 mPa·s/100° C., an acrylic polymer content of 10.6%, and a number average molecular weight of 4500.

### (Production of Hot-Melt Adhesive Agent (Q) and Cured Resin Product (Q))

The same procedures as in Example 14 were carried out except that 80 parts by weight of the modified alkoxysilane-containing resin (B) was used in place of the modified alkoxysilane-containing resin (A), to prepare a hot-melt adhesive agent (Q) and moisture-cure it, so that a cured resin product (Q) was produced.

When the heat resistance and tensile strength of the cured resin product (Q) thus produced were determined by the above methods, the cured resin product (Q) had a softening initiation temperature of 300° C. and a tensile strength of 1.96 MPa (cf. Table 4).

### Example 16

### (Production of Alkoxysilane-Containing Resin (Q))

A 1-liter reaction flask equipped with a reflux condenser, a dropping funnel provided with a nitrogen gas inlet tube, a thermometer, and a stirrer was charged with 575.8 parts by weight of a polyester polyamide polycarboxylic acid (C) and 0.092 parts by weight of magnesium stearate (0.050 parts by mole per 100 parts by mole of the carboxyl group of the polyester polyamide polycarboxylic acid), and heated up to 120° C. with a mantle heater while introducing nitrogen.

Subsequently, 78.3 parts by weight of γ-isocyanatopropyl triethoxysilane (trade name: KBE9007, manufactured by Shin-Etsu Chemical Co., Ltd., isocyanate group content: 16.7% by weight) (the NCO/COOH equivalent ratio: 1.00) was added dropwise thereto over 1 hour using the dropping funnel. After completion of the dropwise addition, the reaction was continued at a reaction temperature of 120° C. for 6 hours, to produce an alkoxysilane-containing resin (Q).

The alkoxysilane-containing resin (Q) thus produced had an isocyanate group content of 0.2% by weight, an acid value of 3.6 mg KOH/g, a viscosity of 5800 mPa·s/100° C., and a number average molecular weight of 5000.

The ¹H-NMR of the alkoxysilane-containing resin (Q) produced was measured. Referring to the NMR chart, when the integral for 2 H of the methylene group portion of the γ-isocyanatopropyl triethoxysilane derivative that appeared at a chemical shift of 0.5 to 0.6 ppm was determined to be 2.0000, the amide conversion was calculated from the integral for the amide NH that appeared at a chemical shift of 7.7 to 7.8 ppm. As a result, the amide conversion was found to be 90%.

### (Production of Modified Alkoxysilane-Containing Resin (C))

A 1-liter reaction flask equipped with a reflux condenser, a dropping funnel provided with a nitrogen gas inlet tube, a thermometer, and a stirrer was charged with 255.2 parts by weight of an alkoxysilane-containing resin (Q) and heated up to 120° C. with a mantle heater while introducing nitrogen.

Next, a solution obtained by homogeneously mixing 18.5 parts by weight of γ-methacryloxypropyl trimethoxysilane (trade name: LS3380, manufactured by Shin-Etsu Chemical Co., Ltd.) and 56.1 parts by weight of n-butyl methacrylate, and 13.8 parts by weight of PERHEXA C (a reaction initiator manufactured by NOF Corporation, 70% by weight of hydrocarbon solution of 1,1-bis(t-butylperoxy)cyclohexane) was added dropwise to the above-mentioned flask at a uniform rate over 4 hours using the dropping funnel.

After completion of the dropwise addition, the reaction was continued at 120° C. for 4 hours. Subsequently, the unreacted γ-methacryloxypropyl trimethoxysilane and n-butyl methacrylate were analyzed by a gas chromatograph and their acrylic monomer conversions were determined. As a result, the acrylic monomer conversions of the γ-methacryloxypropyl trimethoxysilane and the n-butyl methacrylate were found to be 89.9% by weight and 90.7% by weight, respectively. After completion of the reaction, the reaction solution was subjected to pressure reduction for 4 hours on the conditions of 120° C., 1.3 kPa or less, and the unreacted acrylic monomers were removed, to produce a modified alkoxysilane-containing resin (C).

The modified alkoxysilane-containing resin (C) thus produced had a viscosity of 10300 mPa·s/100° C., an acrylic polymer content of 20.9%, and a number average molecular weight of 4800.

### (Production of Hot-Melt Adhesive Agent (R) and Cured Resin Product (R))

The same procedures as in Example 14 were carried out except that 80 parts by weight of the modified alkoxysilane-containing resin (C) was used in place of the modified alkoxysilane-containing resin (A), to prepare a hot-melt adhesive agent (R) and moisture-cure it, so that a cured resin product (R) was produced.

When the heat resistance and tensile strength of the cured resin product (R) thus produced were determined by the above methods, the cured resin product (R) had a softening initiation temperature of 270° C. and a tensile strength of 4.30 MPa (cf. Table 4).

### Example 17

### (Production of Modified Alkoxysilane-Containing Resin (D))

A 1-liter reaction flask equipped with a reflux condenser, a dropping funnel provided with a nitrogen gas inlet tube, a thermometer, and a stirrer was charged with 205.1 parts by weight of an alkoxysilane-containing resin (M) and heated up to 120° C. with a mantle heater while introducing nitrogen.

Next, a solution obtained by homogeneously mixing 24.8 parts by weight of γ-methacryloxypropyl trimethoxysilane (trade name: LS3380, manufactured by Shin-Etsu Chemical Co., Ltd.) and 26.5 parts by weight of n-butyl methacrylate, and 18.6 parts by weight of PERHEXA C (a reaction initiator manufactured by NOF Corporation, 70% by weight of hydrocarbon solution of 1,1-bis(t-butylperoxy)cyclohexane) was added dropwise to the above-mentioned flask at a uniform rate over 4 hours using the dropping funnel.

After completion of the dropwise addition, the reaction was continued at 120° C. for 4 hours. Subsequently, the unreacted γ-methacryloxypropyl trimethoxysilane and n-butyl methacrylate were analyzed by a gas chromatograph and their acrylic monomer conversions were determined. As a result, the acrylic monomer conversions of the γ-methacryloxypropyl trimethoxysilane and the n-butyl methacrylate were found to be 90.1% by weight and 90.8% by weight, respectively. After completion of the reaction, the reaction solution was subjected to pressure reduction for 4 hours on the conditions of 120° C., 1.3 kPa or less, and the unreacted acrylic monomers were removed, to produce a modified alkoxysilane-containing resin (D).

The modified alkoxysilane-containing resin (D) thus produced had a viscosity of 9500 mPa·s/100° C., an acrylic polymer content of 18.5%, and a number average molecular weight of 3200.

### (Production of Hot-Melt Adhesive Agent (S) and Cured Resin Product (S))

A plastic container was charged with 50 parts by weight of the modified alkoxysilane-containing resin (D), 0.5 parts by weight of stannous octoate, and 0.5 parts by weight of tetraethoxysilane, and was subjected to a vacuum defoaming treatment with a vacuum dryer at 100° C. for 30 minutes, to prepare a one-part moisture-curable hot-melt adhesive agent (S).

The hot-melt adhesive agent (S) was casted on an SUS plate, which an appropriate amount of a releasing agent MIRAX RS-102 (manufactured by Katsuzai Chemicals Corp.) was applied to a surface of and was heated to 100° C., so that the cured resin product after moisture-curing had a thickness of 0.7 to 2.2 mm. The casted product was then left to stand for 48 hours on the conditions of 23° C., 50% RH under air, and was moisture-cured over 48 hours on the conditions of 80° C., 30% RH under air, to produce a cured resin product (S).

When the heat resistance and tensile strength of the cured resin product (S) thus produced were determined by the above methods, the cured resin product (S) had a softening initiation temperature of 280° C. and a tensile strength of 23.8 MPa (cf. Table 4).

### Example 18

### (Production of Hot-Melt Adhesive Agent (T) and Cured Resin Product (T))

A plastic container was charged with 80 parts by weight of the alkoxysilane-containing resin (P), 0.8 parts by weight of stannous octoate, 0.8 parts by weight of tetraethoxysilane, 2.49 parts by weight of γ-aminopropyl triethoxysilane (trade name: KBE903, manufactured by Shin-Etsu Chemical Co., Ltd.), and 2.31 parts by weight of N-β-(aminoethyl)-γ-aminopropyl trimethoxysilane (trade name: KBM603, manufactured by Shin-Etsu Chemical Co., Ltd.), and was subjected to a vacuum defoaming treatment with a vacuum dryer at 100° C. for 30 minutes, to prepare a one-part moisture-curable hot-melt adhesive agent (T).

The hot-melt adhesive agent (T) was casted on an SUS plate, which an appropriate amount of a releasing agent MIRAX RS-102 (manufactured by Katsuzai Chemicals Corp.) was applied to a surface of and was heated to 100° C., so that the cured resin product after moisture-curing had a thickness of 0.7 to 2.0 mm. The casted product was then left to stand for 48 hours on the conditions of 23° C., 50% RH under air, and was moisture-cured over 48 hours on the conditions of 80° C., 30% RH under air, to produce a cured resin product (T).

When the heat resistance and tensile strength of the cured resin product (T) thus produced were determined by the above methods, the cured resin product (T) had a softening initiation temperature of 300° C. and a tensile strength of 1.44 MPa (cf. Table 4).

TABLE 1

| | Ex./Comp. Ex. | | | | |
|---|---|---|---|---|---|
| | Ex. 1 | Ex. 2 | Ex. 3 | Ex. 4 | Ex. 5 |
| Type of Resin | Alkoxysilane- | Alkoxysilane- | Alkoxysilane- | Alkoxysilane- | Alkoxysilane- |
| | Containing | Containing | Containing | Containing | Containing |
| | Resin (A) *1 | Resin (B) *2 | Resin (C) *3 | Resin (D) *4 | Resin (E) |
| Type of Oligomer | Polyester Polycarboxylic | Polyester Polycarboxylic | Polyester Polycarboxylic | Polyester Polycarboxylic | Polyester Polycarboxylic |
| | Acid (A) | Acid (A) | Acid (A) | Acid (A) | Acid (B) |
| Isocyanato | γ-Isocyanatopropyl | γ-Isocyanatopropyl | γ-Isocyanatopropyl | γ-Isocyanatopropyl | γ-Isocyanatopropyl |
| Alkoxysilane | Triethoxysilane | Triethoxysilane | Triethoxysilane | Triethoxysilane | Triethoxysilane |
| Compound | | | | | |
| Softening | 310 | 320 | 310 | 310 | 280*⁵ |
| Initiation | | | | | |
| Temperature | | | | | |
| (° C.) | | | | | |
| Tensile Strength | 0.74 | 0.72 | 0.70 | 0.65 | 3.5*⁵ |
| (MPa) | | | | | |

*1 Reaction temperature 70° C.
*2 Reaction temperature 120° C.
*3 Reaction temperature 130° C.
*4 Reaction temperature 150° C.
*⁵Measured values are obtained by mixing alkoxysilane-containing resin (A) and alkoxysilane-containing resin (E) at a mixing ratio of 1:1.

TABLE 2

| | Ex./Comp. Ex. | | | | |
|---|---|---|---|---|---|
| | Ex. 6 | Ex. 7 | Ex. 8 | Ex. 9 | Ex. 10 |
| Type of Resin | Alkoxysilane- | Alkoxysilane- | Alkoxysilane- | Alkoxysilane- | Alkoxysilane- |
| | Containing | Containing | Containing | Containing | Containing |
| | Resin (F) | Resin (G) | Resin (H) | Resin (I) | Resin (J) |
| Type of Oligomer | Polyester Polyamide | Polyester Polyamide | Polyester Polyamide | Polyester Polyamide | Polyester Polyamide |
| | Polycarboxylic Acid (A) | Polycarboxylic Acid (B) | Polycarboxylic Acid (D) | Polycarboxylic Acid (E) | Polycarboxylic Acid (F) |
| Isocyanato | γ-Isocyanatopropyl | γ-Isocyanatopropyl | γ-Isocyanatopropyl | γ-Isocyanatopropyl | γ-Isocyanatopropyl |
| Alkoxysilane | Triethoxysilane | Triethoxysilane | Triethoxysilane | Triethoxysilane | Triethoxysilane |
| Compound | | | | | |
| Softening | 280 | 280 | 270 | 260 | 270 |
| Initiation | | | | | |
| Temperature | | | | | |
| (° C.) | | | | | |
| Tensile Strength | 1.92 | 1.45 | 4.71 | 6.52 | 7.28 |
| (MPa) | | | | | |

TABLE 3

| | Ex./Comp. Ex. | | | | |
|---|---|---|---|---|---|
| | Ex. 11 | Ex. 12 | Ex. 13 | Comp. Ex. 1 | Comp. Ex. 2 |
| Type of Resin | Alkoxysilane- | Alkoxysilane- | Alkoxysilane- | Alkoxysilane- | Alkoxysilane- |
| | Containing | Containing | Containing | Containing | Containing |
| | Resin (K) | Resin (L) | Resin (M) | Resin (N) | Resin (O) |
| Type of Oligomer | Hydrogenated | Amide-Modified | Amide-Modified | Polyester Polyol (A) | Dimer Diol |
| | High-Purity | Dimer Acid (A) | Dimer Acid (B) | | |
| | Dimer Acid | | | | |
| Isocyanato | γ-Isocyanatopropyl | γ-Isocyanatopropyl | γ-Isocyanatopropyl | γ-Isocyanatopropyl | γ-Isocyanatopropyl |
| Alkoxysilane | Triethoxysilane | Triethoxysilane | Triethoxysilane | Triethoxysilane | Triethoxysilane |
| Compound | | | | | |
| Softening Initiation | 300 | 300 | 300 | 220 | 210 |
| Temperature (° C.) | | | | | |
| Tensile Strength | 5.80 | 15.7 | 18.3 | — | — |
| (MPa) | | | | | |

TABLE 4
Ex./Comp. Ex.

| | Ex. 14 | Ex. 15 | Ex. 16 | Ex. 17 | Ex. 18 |
|---|---|---|---|---|---|
| Type of Resin | Modified Alkoxysilane- | Modified Alkoxysilane- | Modified Alkoxysilane- | Modified Alkoxysilane- | Alkoxysilane- |
| | Containing Resin (A) | Containing Resin (B) | Containing Resin (C) | Containing Resin (D) | Containing Resin (P) |
| Alkoxysilane- Containing Resin $( \frac{\begin{matrix}Type \\ of \\ Oligomer\end{matrix}}{\begin{matrix}Isocyanato \\ Alkoxysilane \\ Compound\end{matrix}} )$ | Alkoxysilane- Containing Resin (P) $( \frac{\begin{matrix}Polyester \\ Polycarboxylic \\ Acid ( A )\end{matrix}}{\begin{matrix}γ \text{-} Isocyanatopropyl \\ Triethoxysilane\end{matrix}} )$ | Alkoxysilane- Containing Resin (P) $( \frac{\begin{matrix}Polyester \\ Polycarboxylic \\ Acid ( A )\end{matrix}}{\begin{matrix}γ \text{-} Isocyanatopropyl \\ Triethoxysilane\end{matrix}} )$ | Alkoxysilane- Containing Resin (Q) $( \frac{\begin{matrix}Polyester Polyamide \\ Polycarboxylic \\ Acid ( C )\end{matrix}}{\begin{matrix}γ \text{-} Isocyanatopropyl \\ Triethoxysilane\end{matrix}} )$ | Alkoxysilane- Containing Resin (M) $( \frac{\begin{matrix}Amide \text{-} Modified \\ Dimer \\ Acid ( B )\end{matrix}}{\begin{matrix}γ \text{-} Isocyanatopropyl \\ Triethoxysilane\end{matrix}} )$ | Alkoxysilane- Containing Resin (P) $( \frac{\begin{matrix}Polyester \\ Polycarboxylic \\ Acid ( A )\end{matrix}}{\begin{matrix}γ \text{-} Isocyanatopropyl \\ Triethoxysilane\end{matrix}} )$ |
| Acrylate Compound | $\frac{\begin{matrix}γ \text{-} Methacryloxypropyl \\ Trimethoxysilane\end{matrix}}{n \text{-} Butyl Methacrylate}$ | γ-Methacryloxypropyl Trimethoxysilane | $\frac{\begin{matrix}γ \text{-} Methacryloxypropyl \\ Trimethoxysilane\end{matrix}}{n \text{-} Butyl Methacrylate}$ | $\frac{\begin{matrix}γ \text{-} Methacryloxypropyl \\ Trimethoxysilane\end{matrix}}{n \text{-} Butyl Methacrylate}$ | — |
| Softening | 280 | 300 | 270 | 280 | 300 |
| Initiation | | | | | |
| Temperature | | | | | |
| (° C.) | | | | | |
| Tensile Strength | 2.78 | 1.96 | 4.30 | 23.8 | 1.44 |
| (MPa) | | | | | |

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The alkoxysilane-containing resin and modified alkoxysilane-containing resin of the present invention are suitably used as one-part moisture-curable hot-melt adhesive agents for bonding together an adherend such as steel plate, plastics, rubber, wood, and paper.

1. An alkoxysilane-containing resin produced by reacting a terminal carboxyl group-containing oligomer and an isocyanato alkoxysilane compound.

2. The alkoxysilane-containing resin according to claim 1, wherein the terminal carboxyl group-containing oligomer is at least one kind selected from the group consisting of
polyester polycarboxylic acid produced by reaction between a polybasic acid and a polyhydric alcohol,
polyester polyamide polycarboxylic acid produced by reaction between the polyester polycarboxylic acid and a polyisocyanate compound,
dimer acid, and
amide-modified dimer acid produced by reaction between the dimer acid and a polyisocyanate compound.

3. The alkoxysilane-containing resin according to claim 1, wherein the isocyanato alkoxysilane compound is represented by the following general formula (1): 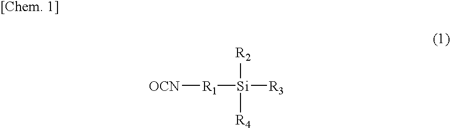
(wherein R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

4. A modified alkoxysilane-containing resin produced by reacting
an alkoxysilane-containing resin produced by reacting a terminal carboxyl group-containing oligomer with an isocyanato alkoxysilane compound, and
an ethylenically unsaturated bond-containing compound.

5. The modified alkoxysilane-containing resin according to claim 4, wherein the terminal carboxyl group-containing oligomer is at least one kind selected from the group consisting of
polyester polycarboxylic acid produced by reaction between a polybasic acid and a polyhydric alcohol,
polyester polyamide polycarboxylic acid produced by reaction between the polyester polycarboxylic acid and a polyisocyanate compound,
dimer acid, and
amide-modified dimer acid produced by reaction between the dimer acid and a polyisocyanate compound.

6. The modified alkoxysilane-containing resin according to claim 4, wherein the isocyanato alkoxysilane compound is represented by the following general formula (1): 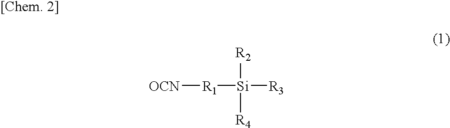
(wherein R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

7. The modified alkoxysilane-containing resin according to claim 4, wherein the ethylenically unsaturated bond-containing compound is an acrylate compound.

8. The modified alkoxysilane-containing resin according to claim 7, wherein the acrylate compound comprises at least one acrylate compound selected from the group consisting of a compound represented by the following general formula (2) and compounds represented by the following general formula (3): 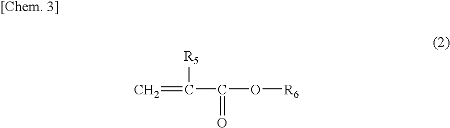
(wherein R5 represents a hydrogen atom, a halogen atom, or an alkyl group having 1 to 12 carbon atoms, and R6 represents a monovalent hydrocarbon group having 1 to 20 carbon atoms,) 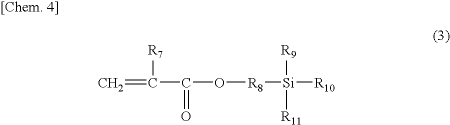
(wherein R7 represents a hydrogen atom, a halogen atom, or an alkyl group having 1 to 12 carbon atoms, R8 represents an alkylene group having 1 to 20 carbon atoms, and R9, R10, and R11 are the same or different from each other, and each represents an alkoxy group or an alkyl group having 1 to 20 carbon atoms, with proviso that at least one of R9, R10, and R11 represents an alkoxy group.)

9. A hot-melt adhesive agent comprising:
an alkoxysilane-containing resin produced by reacting a terminal carboxyl group-containing oligomer and an isocyanato alkoxysilane compound; and/or
a modified alkoxysilane-containing resin produced by reacting the alkoxysilane-containing resin and an ethylenically unsaturated bond-containing compound.

10. The hot-melt adhesive agent according to claim 9, being a one-part moisture-curable adhesive agent.

11. A cured resin product produced by curing
an alkoxysilane-containing resin produced by reacting a terminal carboxyl group-containing oligomer and an isocyanato alkoxysilane compound; and/or
a modified alkoxysilane-containing resin produced by reacting the alkoxysilane-containing resin and an ethylenically unsaturated bond-containing compound.

12. A method for producing an alkoxysilane-containing resin comprising the step of
reacting a terminal carboxyl group-containing oligomer and an isocyanato alkoxysilane compound
in the presence of a catalyst selected from alkali metal salts and/or alkaline earth metal salts in an amount 0.001 to 10 parts by mole per 100 parts by mole of all the carboxyl groups in the terminal carboxyl group-containing oligomer.

13. The method for producing an alkoxysilane-containing resin according to claim 12, wherein the reaction is performed at 150° C. or less.

14. The method for producing an alkoxysilane-containing resin according to claim 12, wherein the catalyst is magnesium stearate.

15. The method for producing an alkoxysilane-containing resin according to claim 12, wherein the terminal carboxyl group-containing oligomer is at least one kind selected from the group consisting of
polyester polycarboxylic acid produced by reaction between a polybasic acid and a polyhydric alcohol,
polyester polyamide polycarboxylic acid produced by reaction between the polyester polycarboxylic acid and a polyisocyanate compound,
dimer acid, and
amide-modified dimer acid produced by reaction between the dimer acid and a polyisocyanate compound.

16. The method for producing an alkoxysilane-containing resin according to claim 12, wherein the isocyanato alkoxysilane compound is represented by the following general formula (1): 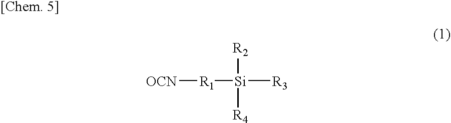
(wherein R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

17. A method for producing a modified alkoxysilane-containing resin comprising the steps of:
producing an alkoxysilane-containing resin by reacting a terminal carboxyl group-containing oligomer and an isocyanato alkoxysilane compound
in the presence of a catalyst selected from alkali metal salts and/or alkaline earth metal salts in an amount 0.001 to 10 parts by mole per 100 parts by mole of all the carboxyl groups in the terminal carboxyl group-containing oligomer; and
reacting the alkoxysilane-containing resin and an ethylenically unsaturated bond-containing compound.

18. The method for producing a modified alkoxysilane-containing resin according to claim 17, wherein the terminal carboxyl group-containing oligomer and the isocyanato alkoxysilane compound are reacted at 150° C. or less.

19. The method for producing a modified alkoxysilane-containing resin according to claim 17, wherein the catalyst is magnesium stearate.

20. The method for producing a modified alkoxysilane-containing resin according to claim 17, wherein
using alkyl peroxide as a reaction initiator,
the alkoxysilane-containing resin and the ethylenically unsaturated bond-containing compound are reacted.

21. The method for producing a modified alkoxysilane-containing resin according to claim 20, wherein the reaction initiator is peroxyketal.

22. The method for producing a modified alkoxysilane-containing resin according to claim 17, wherein the terminal carboxyl group-containing oligomer is at least one kind selected from the group consisting of
polyester polycarboxylic acid produced by reaction between a polybasic acid and a polyhydric alcohol,
polyester polyamide polycarboxylic acid produced by reaction between the polyester polycarboxylic acid and a polyisocyanate compound,
dimer acid, and
amide-modified dimer acid produced by reaction between the dimer acid and a polyisocyanate compound.

23. The method for producing a modified alkoxysilane-containing resin according to claim 17, wherein the isocyanato alkoxysilane compound is represented by the following general formula (1): 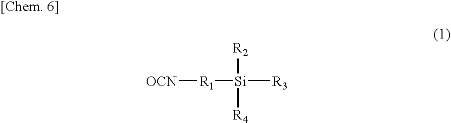
(wherein R1 represents an alkylene group having 1 to 20 carbon atoms, and R2, R3, and R4 may be the same or different from each other, and each represents an alkoxy group or an alkyl group having 1 to 20 carbon atoms, with proviso that at least one of R2, R3, and R4 represents an alkoxy group.)

24. The method for producing a modified alkoxysilane-containing resin according to claim 17, wherein the ethylenically unsaturated bond-containing compound is an acrylate compound.

25. The method for producing a modified alkoxysilane-containing resin according to claim 24, wherein the acrylate compound comprises at least one acrylate compound selected from the group consisting of a compound represented by the following general formula (2) and a compound represented by the following general formula (3): 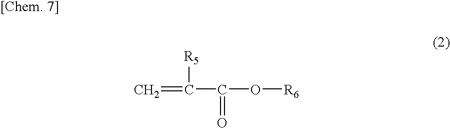
(wherein R5 represents a hydrogen atom, a halogen atom, or an alkyl group having 1 to 12 carbon atoms, and R6 represents a monovalent hydrocarbon group having 1 to 20 carbon atoms,) 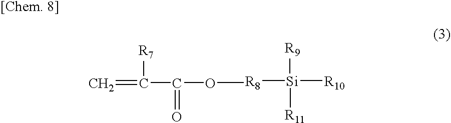
(wherein R7 represents a hydrogen atom, a halogen atom, or an alkyl group having 1 to 12 carbon atoms, R8 represents an alkylene group having 1 to 20 carbon atoms, and R9, R10, and R11 are the same or different from each other, and each represents an alkoxy group or an alkyl group having 1 to 20 carbon atoms, with proviso that at least one of R9, R10, and R11 represents an alkoxy group.)
